(19) United States
(12) Patent Application Publication
(10) Pub. No.: US 2009/0038228 A1
(43) Pub. Date: Feb. 12, 2009

(54) METHOD AND APPARATUS FOR WINDOW CLOSING IN THE SLIDING WINDOW SYSTEM

(76) Inventor: Kwang-Seok Lee, Daegu (KR)

Correspondence Address: NEIFELD IP LAW, PC, 4813-B EISENHOWER AVENUE, ALEXANDRIA, VA, 22304, US

(21) Appl. No.: 12/159,122

(22) PCT Filed: Dec. 29, 2006
(86) PCT No.: PCT/KR2006/005909

§ 371 Date: Jun. 25, 2008

(30) Foreign Application Priority Data
Dec. 29, 2005 (KR) 10-2005-0133971
Mar. 15, 2006 (KR) 10-2006-0023871

(51) Int. Cl. E05F 11/02; E06B 3/46

(52) U.S. Cl. 49/360; 49/506

(57) ABSTRACT

Provided are an apparatus and method for opening and closing a window by slidably moving a movable window sash or door (hereinafter collectively called a ‘movable window sash’) with respect to a fixed window sash or door (hereinafter collectively called a ‘fixed window sash’). The apparatus is designed such that the movable window sash cannot only slide along a rail mounted within a blank frame but also be separated from a roller to move back and forth from any position on a rail toward the blank frame or the fixed window sash in a perpendicular direction with respect to a length direction of the rail, thus allowing the entire seal member interposed between either the blank frame or the fixed window sash and the movable window sash to be uniformly pressed in the perpendicular direction. Thus, excellent soundproofing, air tightness (windproofing), water tightness, insulation performance, and wind pressure resistance can be provided. Furthermore, the sliding window system has a simplified opening/closing structure and a minimum number of components, and low manufacturing cost.

### TECHNICAL FIELD

The present invention relates to a window and door system such as sliding doors or windows, and more particularly, to a method and apparatus for opening/closing a window in a sliding window system by slidably moving a movable window or door (hereinafter collectively called ‘movable window’) with respect to a fixed window or door (hereinafter collectively called ‘fixed window’).

### BACKGROUND ART

FIGS. 1 to 3 illustrate a typical configuration of a sliding window system such as sliding windows or doors. Referring to FIGS. 1 to 3, the sliding window system includes a movable window sash 4 holding a glass pane, etc., and a blank frame 1 that has top and bottom rails 1a and 1b for slidably guiding the moving window sash 4 and that is mounted in a wall of a building. A roller 4a is attached to the bottom rail 1b so that the movable window sash 4 can smoothly move along the rail 1b. The movable window sash 4 holding the glass pane or a panel is mounted in the blank frame 1.

However, such a typical sliding window system having the above-mentioned typical and simple configuration has a gap (refer to FIG. 2) that is formed between either the top or bottom rail 1a or 1b of the blank frame 1 and the movable window sash 4. In addition, as shown in FIG. 3, in a case that the movable window sash 4 is closed, a gap is formed at a portion where the movable window sash 4 and fixed window sash 2 overlap each other. Thus, it is difficult that the typical sliding window system has soundproofing, air tightness (windproofing), water tightness, insulation performance, and wind pressure resistance. To overcome the drawbacks, as shown in FIGS. 2 and 3, a seal member 3 such as mohair or a rubber gasket is attached between the blank frame 1 and either the fixed or movable window sash 2 or 4. Due to limitations of sealing techniques, such a seal member cannot provide a high sealing effect. Further, it is difficult to maintain consistent performance due to deformation or abrasion of the seal member over time.

In order to reduce the drawbacks of the typical sliding window system described above, other sliding window system having a lift & sliding (‘LS’) type as an opening/closing structure has been conventionally proposed. A sliding movement of a movable window will now be described with reference to FIGS. 4 and 5. Referring to FIG. 4, when a handle 4h mounted to a movable window sash 4 is rotated and a lever mechanism connected with the handle 4h is operated thereby, a roller 4a mounted to a lower end of the movable window sash 4 is pushed downward from the lower end of the movable window sash 4 by the handle 4h and the lever mechanism, and accordingly, the movable window sash 4 is moved upward from a rail 1b due to a reaction force of the roller 4a seated on the rail 1b of a blank frame 1 (refer to an enlarged portion ‘D’ of FIG. 4). Thus, a bottom seal member 3b such as a rubber gasket being in contact with the blank frame 1 so as to maintain a sealing state is separated from the blank frame 1 to allow sliding movement of the movable window sash 4. In addition, referring to FIG. 5, when the handle 4h of the movable window sash 4 is rotated in the opposite direction after the sliding movement of the movable window sash 4, the movable window sash 4 is returned at an original position, that is, the movable window sash 4 is moved downward (refer to an enlarged portion ‘D’ of FIG. 5), thus the bottom seal member 3b such as rubber gasket is pressed by the movable window sash 4, and a gap between the bottom sash 4 and the blank frame 1 is sealed by the pressed bottom seal member 3b.

A gap between an upper end of the movable window sash 4 and the blank frame 1 is sealed as illustrated in enlarged portions ‘U’ of FIGS. 4 and 5. More specifically, when the movable window sash 4 is raised to permit sliding movement, a top seal member 3u mounted on the upper end of the movable window sash 4 is separated from a top guide 1a extended downward from an upper portion of the blank frame 1. When the movable window sash 4 is lowered, the top seal member 3u comes in contact with the top guide 1a to effect a seal.

A gap between a vertical portion of the blank frame 1 and vertical portion of the movable window sash 4 is sealed as illustrated in enlarged portions ‘L’ and ‘R’ of FIGS. 4 and 5. In detail, when a window is completely closed after transverse sliding of the movable window sash 4, a side seal member 3s such as a rubber gasket, etc. is pressed against the gap between the vertical portion of the blank frame 1 and the vertical portion of the movable window sash 4.

However, the above-mentioned window system with LS type has a drawback that it is dynamically difficult for components related to the roller on the lower portion of the movable window sash to lift the heavy-weight of the movable window sash due to the concentration load that is applied to the roller when the movable window sash is opened or closed. Thus, the LS type window system requires that components for moving upward or downward the movable window sash when necessary have high performance and durability. Such a drawback imposes a limitation on the size of an applicable movable window sash because load applied by an excessively large movable window sash frame and a glass pane becomes burdensome.

As described above with reference to FIGS. 4 and 5, another drawback of the LS type window system is that it is difficult to provide a perfect seal between each corner of the movable window sash and the blank frame because top, bottom, and side seal members mounted to one movable window sash effect a seal in different directions using different techniques. In addition, it is also difficult to create a perfect seal between the upper portion of the movable window sash and the top guide, since sealing force generated when the top seal member 3u is elastically contacted on the top guide 1a is lowered. In particular, it is difficult to prevent heat from being transferred from an exterior to an interior through the top guide 1a.

As another example of a conventional window system, the Korean Patent Application No. 10-2003-0010568 is laid open in the Patent Gazette (Korean Patent Laid-Open Publication No. 10-2004-0075123). Referring to FIGS. 6 to 8 in the above-cited reference, the window system is configured such that a window is closed in a state that a sliding window sash is contacted on a rubber buffer by moving backward (toward a blank frame and a fixed window sash) after guide members mounted on front and rear portions of the sliding window sash are respectively pushed away by corresponding guide rollers (being mounted on the blank frame and the fixed window) in a final closing step. The conventional window system having the above-mentioned configuration requires a large force to completely close the window, because a large friction force is generated when the guide member of the sliding window sash is inserted between the guide roller and the rubber buffer at the distal end when the sliding window is closed. Conversely, when the sliding window is opened, a large force is also required so as to overcome friction forces that act against pressure forces applied to top, bottom, left, and right rubber buffers. Another drawback is that transverse friction pressure is applied to the rubber buffer while the sliding window is closed, so as to created a seal between the rubber buffer and the guide member when the sliding window sash and guide member further move toward the blank frame (in a closing direction) in a state that the rubber buffer and the guide member are contacted on each other. The transverse friction pressure degrades durability and lifespan of a rubber seal member. Yet another drawback lies in a technical configuration and operation of a movable member mounted on a roller part of the sliding window sash as illustrated in FIGS. 9 to 12 in the above-cited reference. It is described in the detailed description of the cited reference that the sliding window sash is freely slidable without contacting or interfering with a seal member (i.e., rubber buffer) positioned to the rear direction of the sliding window sash in a case that a central load of the sliding window sash become eccentric toward the interior due to a tilted structure of a roller coupling part while the sliding window sash is coveted from an opened state to a closed state. However, actually, in a case that a user in the house opens/closes the window, that is, the user holds a handle and pushes the sliding window sash backwards, at the same time the user transversely slides the sliding window, the window system disclosed in the above-cited reference has a problem in that contact friction between the sliding window sash and the seal member occurs due to the absence of a means for actively controlling a gap between the roller and the rail. Furthermore, since the above window system is configured such that a lower portion of the sliding window sash is tilted towards the interior of the house, the diameter of a groove formed on an upper portion of the sliding window sash is typically larger than that of a groove formed on a lower portion of the sliding window sash so that it is easier to remove or reinstall the sliding window sash from or within the blank frame. Because this creates a longitudinal clearance between the upper portion of the sliding window sash and the blank frame, fixed force resulting from deadweight of the window obtained from the tilted structure of the roller coupling part of the bottom sash window does not occur to the upper portion of the sliding window sash. Thus, another problem of the conventional window system is that front and rear gaps between a top guide of the blank frame and the upper portion of the sliding window sash cause the upper portion of the sliding window sash to rattle and move back and forth. The front and rear gaps between the top guide and the upper portion of the sliding window sash have a width equal to front and rear gaps between a bottom guide and the lower portion of the sliding window sash.

To overcome the drawbacks of the typical sliding window system, a conventional sliding window system with an opening/closing structure called Arm Rotation & Sliding also been proposed. Referring to FIG. 6, the proposed conventional sliding window system includes a blank frame 1, a seal member 3 disposed on the periphery of the blank frame 1, a rail 1a seated within the blank frame 1, a roller 4a mounted within the rail 1a, a fixed window sash (not shown), a movable window sash 4, and a cantilever arm 4b supporting the movable window sash 4. The cantilever arm 4b is coupled to the roller 4a. The movable window sash 4 moves along an axis of the rail 1a with assistance of the roller 4a to slidably open and close the window. As the cantilever arm 4b is folded in a direction indicated by ‘a’, the movable window sash 4 rotates in a counterclockwise direction with respect to the axis of the rail 1a and comes into contact with the seal member 3 such as rubber gasket. Thus, the conventional sliding window system having the above-mentioned configuration provides tightness against sound, air, and water, insulation performance, and wind pressure resistance. However, the conventional sliding window system with the movable window sash 4 mounted on the cantilever arm 4b has a limitation on the size of the movable window sash 4 due to load. Furthermore, components such as roller 4a, the rail 1a, and the cantilever arm 4b should be manufactured to have high stiffness so that a cantilever support structure can withstand the eccentric load of the movable window sash 4 with heavyweight. Therefore, productivity becomes degraded and the manufacturing cost becomes increased. Furthermore, such a rotating structure of the arm type generally has the cantilever arm 4b that is only mounted on a lower portion of the movable window sash. Thus, an upper portion of the movable window sash independently moves instead of cooperating with other components before the movable window sash is completely closed. Another drawback is that the upper portion of the movable window sash is more likely to move back and forth due to wind pressure when high wind blows in a state that the movable window sash is not completely closed, making a user feel uneasy about the movement of the window.

### DISCLOSURE OF INVENTION

### Technical Problem

In order to solve the above problems, the present invention, which relates to a window system for opening and closing a window by slidably moving a movable window or door (hereinafter collectively called a ‘movable window’) with respect to a fixed window or door (hereinafter collectively called a ‘fixed window’), provides a window system having outstanding soundproofing, air tightness (windproofing), water tightness, insulation performance, and wind pressure resistance. The present invention also provides a window system with a simplified opening/closing structure, a minimum number of components, and low manufacturing cost. The present invention also provides a window system that has a high-stiffness structure for supporting a glass pane or panel, that has a reduced cross-sectional profile of a sash including components for providing required primary performances such as soundproofing, air tightness, water tightness, insulation performance, and wind pressure resistance, and that can provide increased glass pane size and improved lighting and openness. The present invention also provides a window system designed such that limitations of precision are reduced during construction and construction failure rate is significantly reduced.

In particular, the present invention provides a window system designed such that a movable window sash can slide along a rail mounted within a blank frame and a movable window sash can be separated from a roller to move back and forth from any position on a rail toward the blank frame or fixed window sash in a perpendicular direction with respect to a length direction of the rail, thus allowing the entire seal member interposed between either the blank frame or a fixed window sash and the movable window sash to be uniformly pressed in the perpendicular direction. Thus, a sealing effect providing soundproofing, air tightness (windproofing), water tightness, insulation performance, and wind pressure resistance is maximized. Furthermore, eccentric pressure applied to the seal member and friction force caused by the pressure are eliminated, thus providing high sealing performance and durability of the seal member.

The main feature of the present invention is to provide a sliding window system including: upper and lower frames of a movable window sash that comes in contact with a blank frame during a seal operation; rail guide assembly and roller assembly separated from the upper and lower frames and allow the movable window sash to slidably move along top and bottom rails fixed to the blank frame; and connecting members such as slant guide holes and guide protrusions disposed between the upper frame and a bottom plate of the rail guide assembly and between the lower frame and a top plate of the roller assembly such that they are fitted with each other as the guide protrusion slides across the slant guide hole. When slidable movement of a movable window sash is completed at any position on the top and bottom rails, a movement force including a direction component parallel with respect to the length direction is applied to the roller assembly and the rail guide assembly to cause sliding between the slant guide hole and the guide protrusion in an slant direction. The sliding allows the upper and lower frames of the movable window sash to move in a front or rear direction that is perpendicular to the length direction of the top and bottom rails so that they contact the blank frame with the seal member being interposed therebetween.

Another main feature of the present invention is to provide a sliding window system having a lubricant member that prevent concentration of friction and reduce frictional resistance at a boundary between the upper frame of the movable window sash and the rail guide assembly and between the lower frame and the top plate of the roller assembly to allow smooth movement of the upper and lower frames in a front or rear direction.

### Technical Solution

To achieve the above objects, according to an aspect of the present invention, there is provided an apparatus for opening/closing a window in a sliding window system including a sliding window or sliding door including: a roller assembly and a rail guide assembly mounted such that a movable window slidably moves along top and bottom rails fixed to a blank frame for opening and closing; a movable window sash that fixedly supports a glass pane or panel, and that comprises an upper frame separated from the rail guide assembly and mounted under the rail guide assembly and a lower frame separated from the roller assembly and mounted on the roller assembly; connecting members for connecting between the separated upper frame and rail guide assembly and between the lower frame and the roller assembly; and an opening/closing device that is mounted on the movable window sash and that applies a movement force including a direction component parallel with respect to the length direction of the top and bottom rails to the rail guide assembly and the roller assembly at any position on the top and bottom rails in order to generate a relative displacement in the connecting members, the relative displacement including a component of displacement perpendicular with respect to the length direction of the top and bottom rails.

In a preferred embodiment thereof, an apparatus for opening/closing a window in a sliding window system including a sliding window or sliding door includes: a roller assembly and a rail guide assembly mounted such that a movable window slidably moves along top and bottom rails fixed to a blank frame for opening and closing; a movable window sash that fixedly supports a glass pane or panel, and that comprises an upper frame separated from the rail guide assembly and mounted under the rail guide assembly and a lower frame separated from the roller assembly and mounted on the roller assembly; at least one slant guide hole and at least one guide protrusion for respectively connecting between the separated upper frame and rail guide assembly and between the lower frame and the roller assembly; and an opening/closing device that is mounted on the movable window sash and applies a movement force including a direction component parallel with respect to the length direction of the top and bottom rails to the rail guide assembly and the roller assembly at any position on the top and bottom rails in order to generate a relative displacement between the at least one slant guide hole and the at least one guide protrusion, the relative displacement including a component of displacement perpendicular with respect to the length direction of the top and bottom rails.

According to the present invention, the opening/closing device applies a movement force of the same transverse direction to the roller assembly and the rail guide assembly in upper and lower structures of the movable window sash and the at least one slant guide hole formed in the upper and lower structures of the movable window sash are slanted in the same direction when viewed from a plane of the movable window sash. Alternatively, the opening/closing device applies a movement force to the roller assembly and the rail guide assembly in laterally opposite directions and the at least one slant guide hole formed in the upper and lower structures of the movable window sash are slanted in opposite directions that are bilaterally symmetric to each other when viewed from a plane of the movable window sash.

According to another aspect of the present invention, there is provided a method for opening/closing a window in a sliding window system, including the steps of: separating upper and lower frames of a movable window sash that comes in contact with a blank frame during a seal operation from a rail guide assembly and a roller assembly; providing connecting members to connect between the upper frame of the movable window sash and the rail guide assembly and between the lower frame and the roller assembly; operating an opening/closing device such that the connecting members slide on the roller assembly and the rail guide assembly in an slant direction at any position on top and bottom rails; and moving the upper and lower frames of the movable window sash separated from the rail guide assembly and roller assembly in a front or rear direction that is perpendicular to the length direction of the top and bottom rails as the slant sliding occurs, so that the movable window sash contacts a seal member interposed between the blank frame and the movable window sash at uniform pressure in the same direction during closing or is separated from the seal member during opening.

In a preferred embodiment thereof, a method for opening/closing a window in a sliding window system includes the steps of: separating upper and lower frames of a movable window sash that comes in contact with a blank frame during a seal operation from a rail guide assembly and a roller assembly, forming at least one slant guide hole and at least one guide protrusion between the upper frame of the movable window sash and the rail guide assembly and between the lower frame and the roller assembly, and fitting the at least one guide protrusion into the at least one slant guide hole to connect between the upper frame and the rail guide assembly and between the lower frame and the roller assembly; operating an opening/closing device such that sliding occurs between the at least one slant guide hole and the at least one guide protrusion on the roller assembly and the rail guide assembly in an slant direction at any position on top and bottom rails; and moving the upper and lower frames of the movable window sash separated from the rail guide assembly and roller assembly in a front or rear direction that is perpendicular to the length direction of the top and bottom rails, so that the movable window sash contacts a seal member interposed between the blank frame and the movable window sash at uniform pressure in the same direction during closing or is separated from the seal member during opening.

In the step of operating the opening/closing device, a transverse movement force being parallel to the length direction of the top and bottom rails is applied in the same direction to the rail guide assembly and the roller assembly to allow sliding in the same slant direction between the at least one slant guide hole and the at least one guide protrusion on the rail guide assembly and the roller assembly. Accordingly, the upper and lower frames of the movable window sash separated from the rail guide assembly and roller assembly move in a front or rear direction that is perpendicular to the length direction of the top and bottom rails so that the movable window sash contacts a seal member interposed between the blank frame and the movable window sash at uniform pressure in the same direction during closing or is separated from the seal member during opening. In another embodiment, in the step of operating the opening/closing device, a transverse movement force parallel to the length direction of the top and bottom rails is applied in laterally opposite directions to the rail guide assembly and the roller assembly to allow sliding in one slant direction between the at least one slant guide hole and the at least one guide protrusion on the rail guide assembly and in another slant direction between the at least one slant guide hole and at least one guide protrusion on the roller assembly. Accordingly, the upper and lower frames of the movable window sash separated from the rail guide assembly and roller assembly move in a front or rear direction that is perpendicular to the length direction of the top and bottom rails, so that the movable window sash contacts the seal member at uniform pressure in the same direction during closing or is separated from the seal member during opening.

Preferably, a sheet-type lubricant member may be provided at a boundary between the lower frame of the movable window sash and the roller assembly to prevent concentration of friction and reduce frictional resistance at the boundary. More preferably, the sheet-type lubricant member may be mounted at a boundary between the upper frame of the movable window sash and the rail guide assembly, between the rail guide of the rail guide assembly and the top rail fixed to the blank frame, or between the side frame of the movable window sash and the blank frame.

The at least one slant guide hole and the at least one guide protrusion may be formed at a boundary between the lower frame of the movable window sash and the roller assembly. In this case, the slant guide is formed to a top plate of the roller assembly and the at least one guide protrusion projects downward from the lower frame of the movable window sash and is fitted into the at least one slant guide hole to allow slidable movement in an slant direction. When the at least one slant guide hole and the at least one guide protrusion are formed at a boundary between the upper frame and the rail guide assembly, the at least one slant guide hole is formed to a bottom plate of the rail guide assembly and the at least one guide protrusion projects upward from the upper frame of the movable window sash and is fitted into the at least one slant guide hole to allow slidable movement in an slant direction. Furthermore, the at least one slant guide hole and the at least one guide protrusion in either or both of upper and lower structures of the movable window sash may be formed at reverse positions unlike those described above.

Preferably, when a movement force of the same direction is applied to the roller assembly and the rail guide assembly in upper and lower structures of the movable window sash according to the operation of the opening/closing device, the at least one slant guide hole formed in the bottom plate of the rail guide assembly and the top plate of the roller assembly are slanted in the same direction as viewed from above the entire movable window sash. Conversely, when a movement force is applied to the roller assembly and the rail guide assembly in laterally opposite directions according to the operation of the opening/closing device, the at least one slant guide hole formed in the bottom plate and the top plate are preferably slanted in opposite directions when viewed from above the entire movable window sash.

Preferably, the rail guide assembly and the roller assembly respectively disposed above and below the upper and lower frames of the movable window sash may further include separation preventing plates for prevent separation of the upper and lower frames of the movable window sash from the bottom plate of the rail guide assembly and the top plate of the roller assembly due to occurrence of an excessive separation displacement between the upper frame and the bottom plate and between the lower frame and the top plate when the upper and lower frames of the movable window sash move in a front or rear direction that is perpendicular with respect to the length direction of the top and bottom rails.

According to an embodiment of the present invention, the opening/closing device for applying a movement force including a direction component parallel with respect to the length direction of the top and bottom rails to the rail guide assembly and the roller assembly includes: a rotating axis member that has a rotary handle and that is mounted along a longitudinal direction of the side frame of the movable window sash; connecting rods that are respectively linked to the top plate of the roller assembly and the bottom plate of the rail guide assembly and transform rotational motion of the rotating axis member into reciprocating motion; and rotating end members that are respectively fitted to the top and bottom of the rotating axis member such that the connecting rods push or pull the top plate of the roller assembly and the bottom plate of the rail guide assembly due to rotation of the rotating axis member to simultaneously move in a parallel direction with respect to the top and bottom rails, each rotating end member having one end fixed to the same position on either top or bottom of the rotary axis member and the other end linked to either of the connecting rods.

According to another embodiment of the present invention, the opening/closing device includes: a side slide bar mounted along a longitudinal direction of the side frame of the movable window sash to allow up and down movement; a rotary handle for applying a force causing the side slide bar to move up and down; a gear set for converting rotational motion of the rotary handle into up-and-down reciprocating motion of the side slide bar; flexible sliders that are connected to top and bottom of the side slide bar and transmit the reciprocating motion to top and bottom of the movable window sash; upper and lower slide bars mounted on the top and bottom of the movable window sash in a horizontal direction so as to interlock with the flexible sliders; and connecting rods respectively linking the upper and lower slide bars to the bottom plate of the rail guide assembly and the top plate of the roller assembly. Various changes and modifications can be made in the construction of the opening/closing device.

The opening/closing device further includes a locking unit for locking the opening/closing device so as to maintain a state in which a seal member interposed between either the blank frame or fixed window sash and the movable window sash to effect a seal is pressed when the movable window sash slidably moves in a front or rear direction so as to become contiguous to the seal member according to the operation of the opening/closing device. In this case, the seal member may be integrally mounted on the blank frame or fixed window sash so as to form a plane. In addition to the locking unit for locking the operation of the opening/closing device, the opening/closing device further includes a locking unit consisting of a hook or stop lug formed on the side slide bar on a side of the movable window sash and a hook or stop lug formed at a position on the blank frame corresponding to the hook or stop lug formed on the side slide bar.

Furthermore, a plurality of rail guide assemblies or a plurality of roller assemblies having a predetermined length may be connected to one another. In this case, a length-adjustable intermediate connecting member is disposed between the plurality of rail guide assemblies or the plurality of roller assemblies to connect between the plurality of rail guide assemblies or roller assemblies.

A method and apparatus for opening and closing a window in a sliding window system according to the present invention allow a movable window sash to be integrally and almost perfectly pressed against an elastic seal member interposed between the movable window sash and blank frame at any position on a rail within the blank frame, thus providing improved soundproofing, air tightness (windproofing), water tightness, insulation performance, and wind pressure resistance. The present invention also prevents damage to the seal member and each component from becoming heavily loaded, thus providing improved durability while making it easier to manage the components than components in a conventional opening and closing apparatus. The apparatus has a minimum number of components, thus offering increased productivity and constructability.

Furthermore, the at last one slant guide hole is portioned into a plurality of sections to perform a locking operation due to an elastic reaction force exerted by pressing the seal member when the movable window sash comes in contact with the seal member mounted on the blank frame, thus providing excellent sound proofing, air tightness (wind proofing), water tightness, and insulation performance without the a separate locking unit.

The present invention also provides a sliding window system with a reduced number of compact, thin components designed to provide soundproofing, air tightness (windproofing), water tightness, insulation performance, and wind pressure resistance. That is, the sliding window system has a simple, slim, large sash, thus lowering the manufacturing costs while maximizing openness of a space through the window.

### BRIEF DESCRIPTION OF THE DRAWINGS

FIGS. 1 to 3 illustrate a typical configuration of a sliding window system;

FIGS. 4 and 5 illustrate a conventional sliding window system with a lift & sliding type for opening/closing a window;

FIG. 6 illustrates a conventional sliding window system using an Arm Rotation & Sliding mechanism;

FIG. 7 illustrates a fundamental configuration of a sliding window system according to an embodiment of the present invention;

FIGS. 8 and 9 are perspective views and enlarged cross-sectional views of main portions of the sliding window system of FIG. 7 for explaining the operating principles thereof;

FIG. 10 is a cross-sectional view illustrating states in which the main portions of the sliding window system of FIGS. 8 and 9 operate.

FIGS. 11 to 13 illustrate additional configurations that can be applied to the sliding window system according to the present invention;

FIG. 14 illustrates the configuration of an opening/closing device according to an embodiment of the present invention;

FIGS. 15 to 20 illustrate main configurations and operation of the opening/closing device of FIG. 14;

FIGS. 21 to 26 illustrate operation of the overall window system including the opening/closing device of FIG. 14;

FIG. 27 illustrates the configuration of an opening/closing device according to another embodiment of the present invention;

FIGS. 28 to 34 illustrate main configurations and operation of the opening/closing device of FIG. 27;

FIGS. 35 to 40 illustrate operation of the overall window system including the opening/closing device of FIG. 27;

FIGS. 41 to 43 illustrate an opening/closing device with modified corners of the sash illustrated in FIG. 27 according to another embodiment of the present invention;

FIGS. 44 and 45 illustrate an opening/closing device with a sash handle having a modified operating structure and an slant guide hole of a bottom sash having a modified slant direction according to another embodiment of the present invention;

FIG. 46 illustrates the configuration of a modified example of the opening/closing device of FIG. 14;

FIGS. 47 and 48 illustrate the configurations of modified examples of the opening/closing device of FIG. 14;

FIG. 49 illustrates a structure changing a direction of a rotating handle using a bevel gear, in an opening/closing device;

FIG. 50 illustrates a modified example of a rail guide assembly and a structure connecting elements according to an embodiment of the present invention;

FIGS. 51 to 55 illustrate configurations of locking units that can be added to an opening/closing device according to embodiments of the present invention;

FIGS. 56 to 60 illustrate various shapes of slant guide holes according to embodiments of the present invention;

FIGS. 61 and 62 illustrate the operation of an opening/closing device with the slant guide hole of FIG. 56;

FIGS. 63 and 64 illustrate the operation of an opening/closing device with the slant guide hole of FIG. 57;

FIGS. 65 and 66 illustrate the operation of an opening/closing device with the slant guide hole of FIG. 58; and

FIG. 67 illustrates an eccentric rotating link bar connecting element replacing an slant guide hole and a guide protrusion according to an embodiment of the present invention.

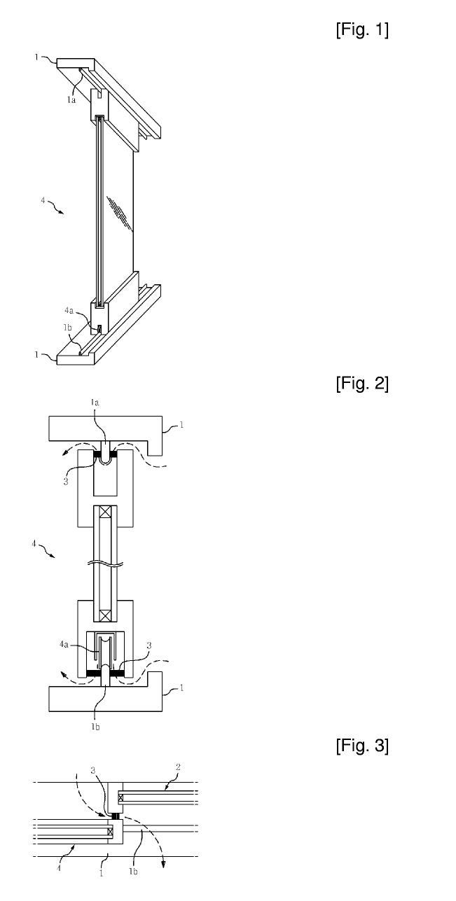

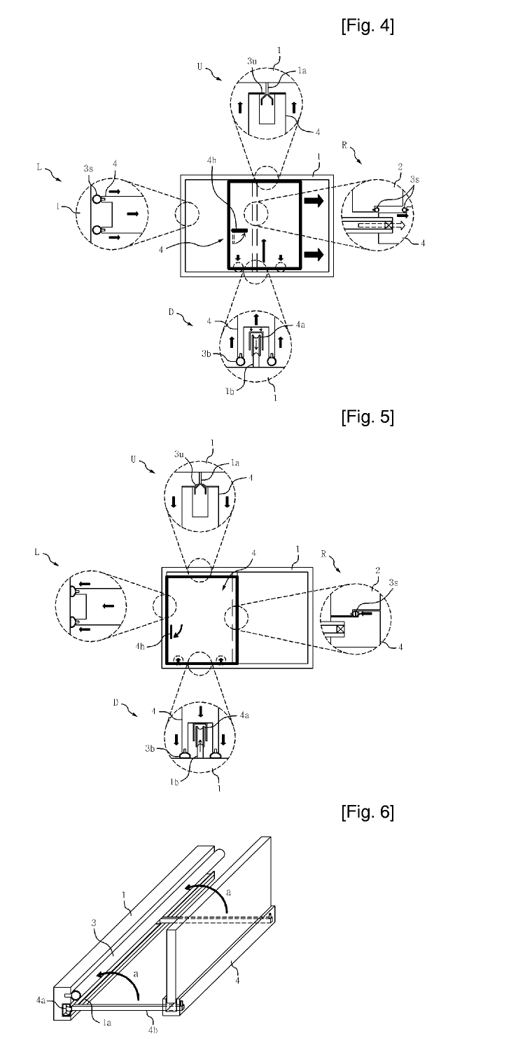

### BEST MODE FOR CARRYING OUT THE INVENTION

The configuration and operating principle of an apparatus for opening/closing a window in a sliding window system and the effect of a method for opening/closing a window in a sliding window system will be described more fully with reference to the accompanying drawings, in which preferred embodiments of the invention are shown.

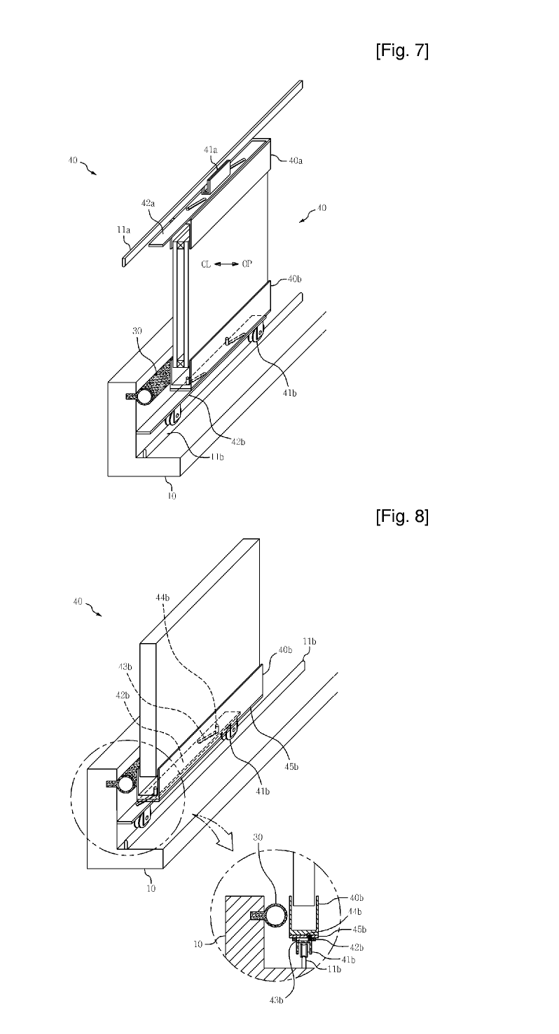

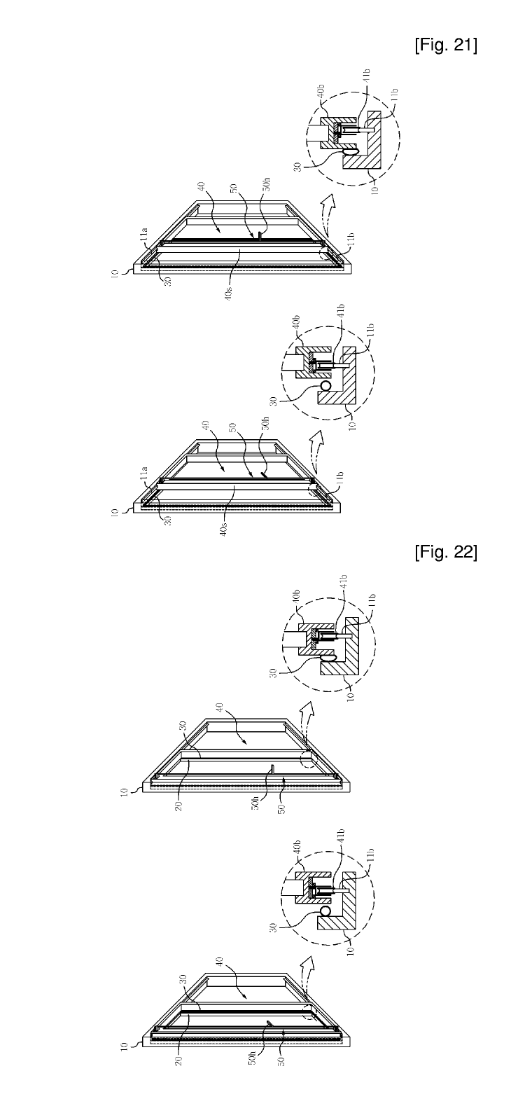

Referring to FIGS. 7 to 9, a sliding window system according to an embodiment of the present invention includes a blank frame 10, top and bottom rails 11a and 11b mounted within the blank frame 10, a movable window sash 40 slidably moving along the top and bottom rails 11a and 11b, a roller assembly 41b and 42b mounted on a bottom of a lower frame 40b of the movable window sash 40, a rail guide assembly 41a and 42a mounted on an upper frame 40a of the movable window sash 40 and respectively engaged with the top rail 11a and the roller 41b of the roller assembly 41b and 42b, and an elastic seal member 30 interposed between either the blank frame 10 or fixed window sash (refer to ‘20’ in FIGS. 21 and 22) and the movable window sash 40. The upper and lower frames 40a and 40b of the movable window sash 40 are separated between the roller assembly 41b and 42b and the rail guide assembly 41a and 42a by operation of an opening/closing device (refer to ‘50’ in FIG. 14) mounted on a side frame (‘40s’ in FIG. 14) of the movable window sash 40 so that the movable window sash 40 moves in forward and backward direction (that is, in a direction indicated by “CL” and “OP” in FIG. 7) that become perpendicular with respect to the length direction of the top and bottom rails 11a and 11b within the blank frame 10, thus allowing the seal member 30 to be uniformly pressed in the perpendicular direction. Accordingly, a window system having an excellent and uniform sealing performance is provided.

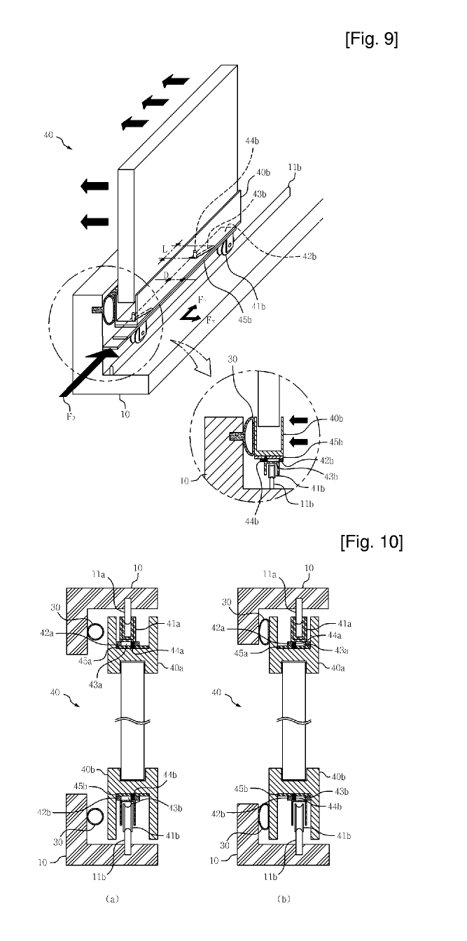

The detailed configuration and operating principle for moving the movable window sash 40 in the perpendicular direction with respect to the length direction of the top and bottom rails 11a and 11b will now be described with reference to FIGS. 8 and 9. When a movement force Fp of a parallel direction with respect to the length direction of the bottom rail 11b is applied to push the roller assembly 41b and 42b as illustrated in FIG. 9 in a state in which the sliding window system is installed as shown in FIG. 8 (before movement for sealing), the movement force Fp is decomposed into horizontal and vertical component forces Fh and Fv due to a slant connecting structure including an slant guide hole 43b formed at a top plate 42b of the roller assembly 41b and 42b (the guide hole 43b is slanted at a predetermined angle with respect to a central symmetry axis as viewed from the plane of the window system) and a guide protrusion 44b projecting downward from the bottom of the lower frame 40b of the movable window sash 40. Because the roller 41b of the roller assembly 41b and 42b is constrained so as not to deviate from the bottom rail 11b in the perpendicular direction with respect to the length direction of the bottom rail 11b, the roller 41b does not move in the perpendicular direction with respect to the length direction of the bottom rail 11b. Thus, a reaction force due to the constraints is exerted so that the lower frame 40b of the movable window sash 40 can move by a width D of the slant guide hole 43b in the perpendicular direction with respect to the length direction of the bottom rail 11b (i.e., in a front or rear direction of the movable window sash).

The horizontal component force Fh acts parallel to the length direction of the rail 11b so that the roller 41b of the roller assembly 41b and 42b is pushed in parallel along the bottom rail 11b or the lower frame 40b of the movable window sash 40 is pulled in parallel against the bottom rail 11b. The sum of both displacements of the horizontal and vertical component forces respectively having the above-mentioned directions is equal to the length L of the slant guide hole 43b in the length direction of the rail 11b. Each displacement may vary depending on the extent to which horizontal movement of the roller 41b along the rail 11b is limited by a friction force and to which horizontal movement of the lower frame 40b or the side frame 40s is limited due to presence of the blank frame.

In a case that the movable window sash 40 has a large size, because a significantly large overall load caused by frames of the movable window and glass pane or panel fitted therein is exerted on a contact surface between the lower frame 40b of the movable window sash 40 and the roller assembly 41b and 42b, a frictional resistance should be overcome to allow smooth sliding movement of the lower frame 40b of the movable window sash 40 on the top plate 42b of the roller assembly 41b and 42b. Accordingly, to minimize the frictional resistance, a sheet-type slide bearing 45b is preferably provided as a lubricant member between the bottom of the lower frame 40b of the movable window sash 40 and the top plate 42b of the roller assembly 41b and 42b. Other equivalents to a lubricant member may be used for performing a lubricating function. If the bottom of the lower frame 40b of the movable window sash 40 is formed of a material having a lubricating function, a separate lubricant sheet may not be needed.

The sheet-type slide bearing 45b is preferably formed of a self-lubricating material (e.g., ‘Turcite’ product) containing as a main component at least one component selected from the group consisting of fluorocarbon complex, polyoxymethylene, nylonmonomer, MC nylon, polymer polyethylene, and Teflon. More preferably, the sheet-type slide bearing 45b is formed of a material that can facilitate a sliding movement between the bottom of the lower frame 40b of the movable window sash 40 and the top plate 42b of the roller assembly 41b and 42b, and that can improve the durability and abrasion resistance therewith. Of course, the sheet-type slide bearing 45b also has a hole through which the guide protrusion 44b can penetrate. In broader terms, it is possible to install the sheet-type slide bearing at a portion of the boundary at which relative displacement occurs as well as across the entire boundary.

On the other hand, the guide protrusion 44b and the slant guide hole 43b may be respectively disposed at reverse positions (not shown) unlike those shown in FIGS. 8 and 9. That is, the guide protrusion 44b may project upward from the top plate 42b of the roller assembly, and the slant guide hole 43b may be formed into the bottom of the lower frame 40b of the movable window sash 40.

Referring to FIG. 10, the load of the movable window sash 40 can be supported by transferring it from the lower frame 40b to the bottom rail 11b through the top plate 42b and the roller 41b. As shown in FIGS. 10(a) and 10(b), even when the movable window sash 40 moves perpendicular with respect to the length direction of the rail 11b, the movable window sash 40 can be stably supported on the bottom rail 11b because the eccentricity extent of the load is small.

While FIGS. 8 and 9 show the operation of the structure disposed under the lower frame 40b of the movable window sash 40, a structure disposed on the upper frame 40a performs substantially the same operation as its counterpart as illustrated in FIGS. 7 and 10. More specifically, the upper frame 40a of the movable window sash 40 is separated from the rail guide assembly 41a and 42a and disposed under a bottom plate 42a of the rail guide assembly 41a and 42b. A guide protrusion 44a and an slant guide hole 43a are respectively formed to the upper frame 40a of the movable window sash 40 and the bottom plate 42a of the rail guide assembly 41a and 42a so as to connect the upper frame 40a of the movable window sash 40 and the bottom plate 42a of the rail guide assembly 41a and 42a to each other. An opening/closing device is mounted on the upper and side frames of the movable window sash 40 to apply a force including a direction component parallel with respect to the length direction of the top rail 11a to the rail guide assembly 41a and 42a. When the force is applied by the opening/closing device to the rail guide assembly 41a and 42a so as to generate relative displacement between the slant guide hole 43a and the guide protrusion 44a, sliding occurs in an slant direction along the relative displacement so that the upper frame 40a of the movable window sash 40 separated from the rail guide assembly 41a and 42a moves in forward and backward direction that includes a component of displacement perpendicular with respect to the length direction of the top rail 11a.

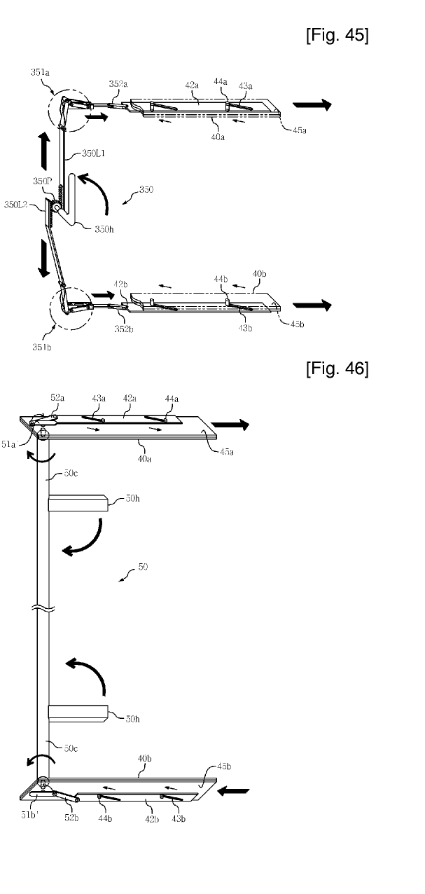

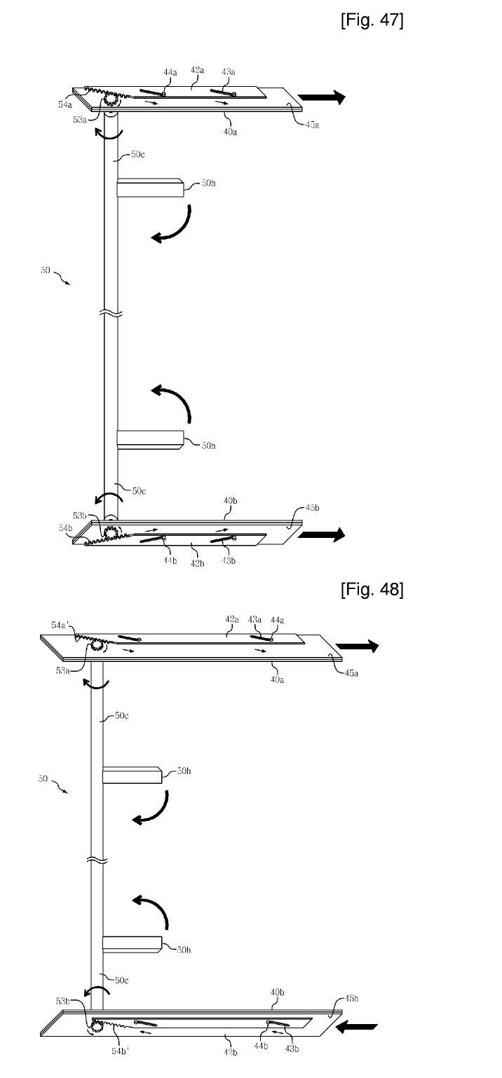

The slant guide hole 43a that is formed to the bottom plate 42a of the rail guide assembly 41a and 42a positioned on the upper frame 40a of the movable window sash 40 may have the same slant direction as the slant direction of the slant guide hole 43b that is formed to the top plate 42b of the roller assembly 41b and 42b positioned under the lower frame 40b, as viewed from above the entire movable window sash. In this case, when the movable window sash 40 moves in a front direction or a rear direction so as to become contiguous to the blank frame 10 or the seal member 30 according to the operation of an opening/closing device (refer to ‘50” in FIGS. 14 to 26, ‘350’ in FIGS. 44 and 45, and ‘50’ in FIG. 47), which will be described later in detail, the bottom plate 42a of the rail guide assembly 41a and 42a and the top plate 42b of the roller assembly 41b and 42b can be pushed or pulled in the same direction according to a specific operation of the opening/closing device so that the upper and lower frames of the movable window sash 40 can slide obliquely along the guide grooves 43a and 43b having the same slant direction to the same extent, thus allowing the upper and lower frames of the movable window sash 40 to Integrally move back or forth.

Conversely, the slant guide hole 43a that is formed to the bottom plate 42a of the rail guide assembly 41a and 42a positioned on the upper frame 40a of the movable window sash 40 may have an slant direction opposite to the slant direction of the slant guide hole 43b that is formed to the top plate 42b of the roller assembly 41b and 42b positioned under the lower frame 40b, as viewed from above the entire movable window sash. In this case, when the movable window sash 40 moves in a front direction or rear direction so as to become contiguous to the blank frame 10 or the seal member 30 according to the operation of an opening/closing device (refer to ‘150” in FIGS. 27 to 40, ‘250’ in FIGS. 41 to 43, and ‘50’ in FIG. 48), which will be described later in detail, the bottom plate 42a of the rail guide assembly 41a and 42a can be pushed or pulled in an opposite direction to the top plate 42b of the roller assembly 41b and 42b according to a specific operation of the opening/closing device so that a balance in transverse sliding movement along the slant guide holes 43a and 43b with opposite slant directions is created between the upper and lower frames of the movable window sash 40, thus allowing the movable window sash 40 to move in the front or the rear direction that is perpendicular with respect to the length directions of the rails 11a and 11b.

A plurality of slant guide holes 43a and 43b and guide protrusions 44a and 44b can be formed to the upper and lower frames 40a and 40b of the movable window sash 40 considering the width of the movable window sash 40.

In this case, it is significantly effective for the entire movable window sash 40 to stably move in a perpendicular direction with respect to the length direction of the rails 11a and 11b. Furthermore, when the plurality of slant guide holes 43a and 43b and guide protrusions 44a and 44b are arranged at equal intervals to each other, a uniform force can be applied to the seal member 30 across the width of the movable window sash 40, thus significantly improving soundproofing, air tightness, insulation performance, water tightness, insulation performance, and wind pressure resistance.

When the movable window sash 40 moves in the front or the rear direction that is perpendicular with respect to the length direction of the rails 11a and 11b so as to seal the window system, each of the roller 41b and the rail guide 41a is firmly fixed to each of the top plate 42b of the roller assembly 41b and 42b and the bottom plate 42a of the rail guide assembly 41a and 42a. Each of the guide protrusions 44a and 44b is securely fixed to each of the upper and lower frames 40a and 40b of the movable window sash 40.

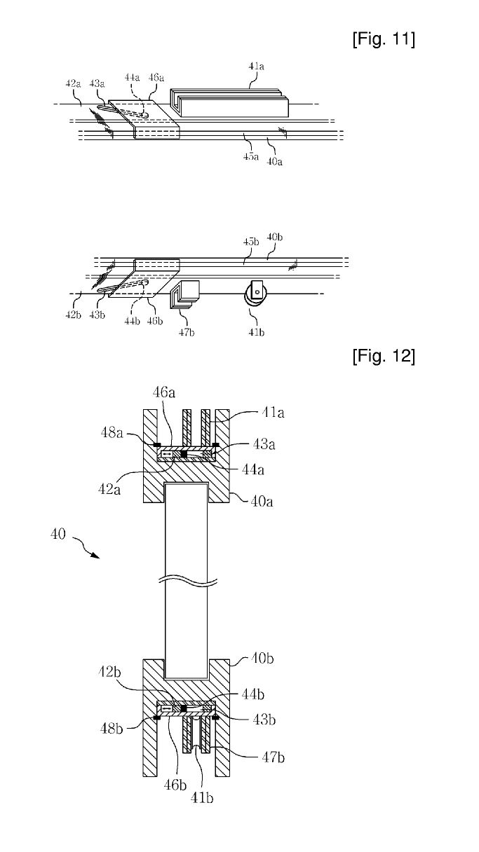

Thus, a repulsive force due to the blank frame 10 and the seal member 30 is applied to the slant guide holes 43a and 43b and guide protrusions 44a and 44b that crosswise move with each other to cause distortion deformation to the bottom or top plate 42a or 42b in which the slant guide hole 43a or 43b is formed. This causes an excessive separation displacement to occur between the upper frame 40a of the movable window sash and the bottom plate 42a of the rail guide assembly 41a and 42a and between the lower frame 40b of the movable window sash and the top plate 42b of the roller assembly 41b and 42b, and accordingly the upper or lower frame 40a or 40b may be separated from the bottom or top plate 42a or 42b. Referring to FIG. 11, to prevent the separation of the upper or lower frame 40a or 40b as well as distortion deformation of the top plate 42b and the bottom plate 42a, separation preventing plates 46a and 46b are rigidly jointed to the upper and lower frames 40a and 40b of the movable window sash 40, respectively. On the other hand, when the upper and lower frames 40a and 40b may be typical frames having upwardly and downwardly extending flanges as illustrated in FIG. 10, the separation preventing plates 46a and 46b may be jointed to the upper and lower frames 40a and 40b as shown in FIG. 12.

Referring to FIGS. 11 and 12, the roller assembly 41b and 42b disposed under the lower frame 40b of the movable window sash 40 further includes a bottom rail guide 47b to prevent separation of the roller assembly 41b and 42b from the bottom rail 11b when the lower frame 40b of the movable window sash moves in the front or the rear direction that is perpendicular with respect to the length direction of the bottom rail 11b.

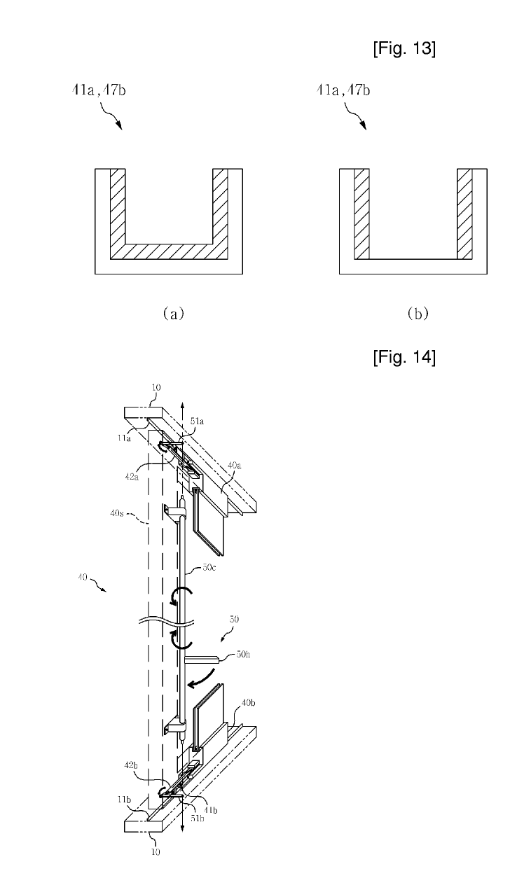

FIGS. 13(a) and 13(b) are cross-sectional views of the rail guides 41a and the bottom rail guides 47b according to preferred embodiments of the present invention. The rail guides 41a and the bottom rail guides 47b shown in FIGS. 13(a) and 13(b) are all configured to prevent their separations from the top and bottom rails 11a and 11b or deformation of the rails 11a and 11b due to the repulsive force exerted when the movable window sash 40 in FIG. 12 moves in the front or rear direction. Each of the rail guides 41a and 47b has a double structure, that is, an outer side of which is formed of metal, and an inner side of which has a sheet type lubricant formed of a self-lubricating material containing as a main component at least one component selected from the group consisting of fluorocarbon complex, polyoxymethylene, nylonmonomer, MC nylon, polymer polyethylene, and Teflon. The metallic outer side prevents deformation of the rail guides 41a and 47b against the repulsive force, and the sheet type lubricant that is adhered on the inner side absorbs external shock and facilitates a sliding movement between the rails 11a and 11b and the rail guides 41a and 47b.

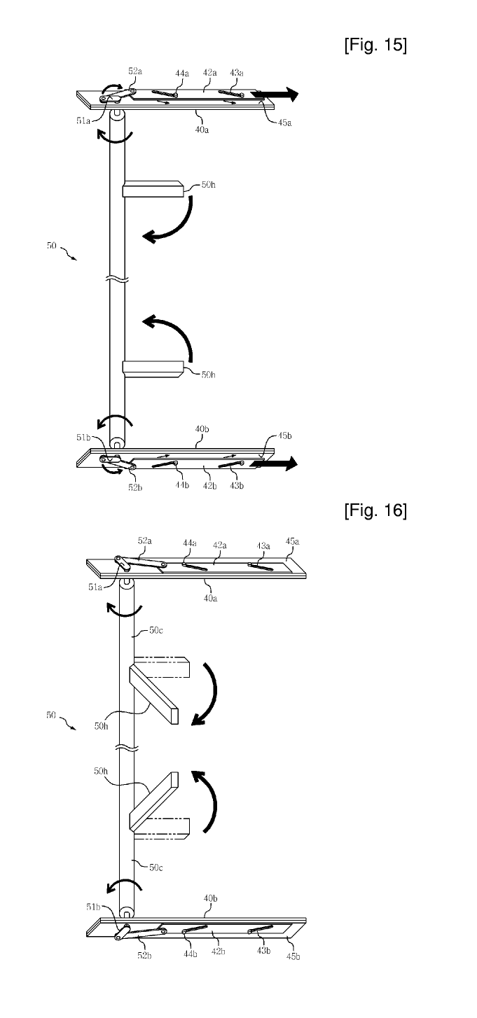

FIG. 14 illustrates the overall configuration of a sliding window system having an opening/closing device according to a preferred embodiment of the present invention (hereinafter referred to as the “first embodiment”). FIGS. 15 and 16 are simplified perspective views illustrating the states of the opening/closing device 50 shown in FIG. 14 before and after rotation.

Referring to FIGS. 15 and 16, the opening/closing device 50 includes a rotating axis member 50c that has a rotary handle 50h and that is mounted along a longitudinal direction of the side frame 40s, connecting rods 52b and 52a that are respectively linked to the top plate 42b of the roller assembly 41b and 42b and the bottom plate 42a of the rail guide assembly 41a and 42a and transform rotational motion into reciprocating motion, and first and second rotating end members 51a and 51b, each of which having one end fixed to either top or bottom of the rotary axis member 50c and the other end linked to either of the connecting rods 52a and 52b. The rotating end members 51a and 51b are respectively fitted to the top and bottom of the rotating axis member 50c such that the connecting rods 52a and 52b push or pull the bottom plate 42a and the top plate 42b due to rotation of the rotating axis member 50c to simultaneously move in a parallel direction with respect to the top and bottom rails 11a and 11b.

The operation of the opening/closing device according to the first embodiment will now be described with reference to FIGS. 15 and 16. When the rotary handle 50h rotates in a direction indicated by an arrow, the rotating axis member 50c and the first and second rotating end members 51b and 51a rigidly jointed to the top and bottom of the rotating axis member 50c rotate in a direction indicated by an arrow so as to push the connecting rods 52a and 52b, the bottom plate 42a, and the top plate 42b. At that time, the guide projections 44a and 44b projecting out from the upper and lower frames 40a and 40b (illustrated as simplified panels) through the sheet-type slide bearings 45a and 45b slidably move along the slant guide holes 43a and 43b, thus causing the bottom plate 42a and the top plate 42b to be obliquely pushed in the forward direction as indicated by an arrow of FIG. 15.

While FIGS. 15 and 16 show that the bottom plate 42a and the top plate 42b are moved obliquely forward to the right, a displacement in the forward and backward direction is actually constrained not to move the rail guide 41a in FIG. 14 and the roller 41b in FIG. 14 respectively fixed to the bottom plate 42a and the top plate 42b because they are secured on the top and bottom rails 11a and 11b. Thus, the upper and lower frames 40a and 40b move obliquely backward to the left, including a component of perpendicular displacement with respect to the length direction of the top and bottom rails 11a and 11b. As described above, the sheet-type slide bearings 45a and 45b minimize friction at boundaries between the upper frame 40a and the bottom plate 42a and between the lower frame 40b and the top plate 42b during the sliding movement.

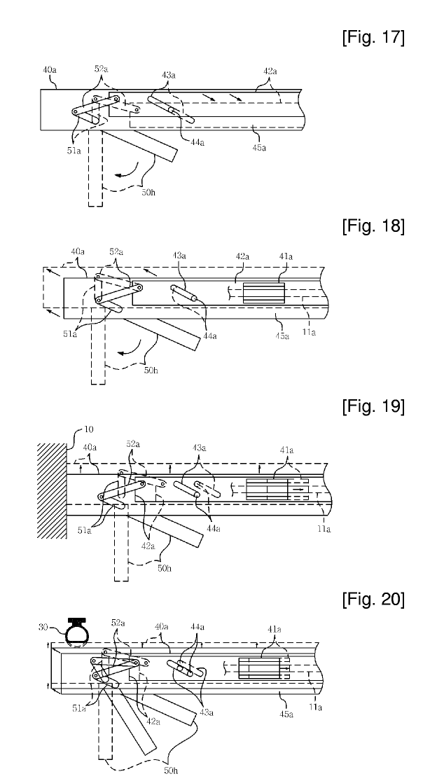

FIGS. 17 to 20 are top views illustrating operation of an upper structure of the movable window sash 40 in FIG. 12. Referring to FIG. 17, when the rotary handle 50h rotates in a direction indicated by an arrow, the first rotating end member 51a rigidly jointed to the top of the rotating axis member 50c rotates to push the connecting rods 52a and the bottom plate 42a in the right direction. At that time, the guide projection 44a projecting out from the upper frame 40a through the sheet-type slide bearing 45a slidably moves along the slant guide holes 43a and 43b, thus causing the bottom plate 42a to be obliquely pushed in the forward direction as indicated by an arrow of FIG. 17.

However, because the rail guide 41a is fixed to the bottom plate 42a and engaged with the top rail 11a within the blank frame 10, the rail guide assembly 41a and 42b cannot move as shown in FIG. 17. A reaction force due to the non-movement is exerted on the upper frame 40a of the movable window sash to move in a direction indicated by an arrow in FIG. 18 (to a state indicated by dotted lines).

Meanwhile, although the rail guide 41a interlocks with the top rail 11a within the blank frame 10, only a component of perpendicular displacement with respect to the length direction of the top rail 11a is completely constrained. That is, a component of parallel displacement with respect to the length direction thereof is not constrained. Thus, when the opening/closing device 50 operates with the side of the movable window sash 40 being in contact with the blank frame 10 as illustrated in FIG. 19, the movable window sash 40 that can accommodate a perpendicular displacement component with respect to the length direction of the top rail 11a, among displacement components in slant direction generated between guide protrusion 44a and the slant guide hole 43a, moves backward in the direction perpendicular to the length direction of the top rail 11a. On the other hand, the rail guide 41a that can accommodate a parallel displacement component with respect to the length direction of the top rail 11a moves right along the top rail 11a.

Furthermore, when the upper frame 40a of the movable window sash 40 moves to the state indicated by dotted lines in the direction of arrows in FIG. 18 so that it comes into contact with the seal member 30 mounted on the blank frame 10, a friction force due to the contact with the seal member 30 acts as a reaction force so that the upper frame 40a can no longer accommodate a parallel displacement component with respect to the length direction of the top rail 11a. Thus, as described above with reference to FIG. 19, the upper frame 40a accommodates only a perpendicular displacement component with respect to the length direction of the top rail 11a while the rail guide assembly 41a and 42a accommodates a parallel displacement component with respect to the length direction thereof to move slightly right along the top rail 11a. FIG. 20 clearly illustrates the operating states of the upper frame 40a and the rail guide assembly 41a and 42a.

Meanwhile, FIGS. 15 and 16 may cause confusion that the top and bottom slant guide holes 43a and 43b will be slant in opposite directions. However, the upper structure of the movable window sash 40 is illustrated in a top perspective view and the lower structure is illustrated in a bottom perspective view for better visualization and understanding of the overall configuration and operating structure. Thus, the top and bottom slant guide holes 43a and 43b are slanted in the same direction as viewed from above the movable window sash 40. The same principle as described with reference to FIGS. 17 to 20 may apply to the lower structures of the movable window sash 40 consisting of the lower frame 40b, the roller assembly 41b and 42b, and the bottom rail 11b.

In particular, while the opening/closing device 50 shown in FIG. 14 is mounted outside the upper and lower frames 40a and 40b of the movable window sash 40, it may be mounted therein.

FIGS. 21 to 26 illustrate operation of the overall sliding window system including the opening/closing device 50 according to the first embodiment. The operation and effects of the opening/closing device 50 will now be described with reference to FIGS. 21 to 26.

FIG. 21 illustrates operation of the sliding window system according to the present invention when the rotary handle 50h of the opening/closing device 50 in FIG. 14 is rotated (see a picture on the right) in a state in which the movable window sash slidably moves closer to the inside of the blank frame 10 for complete closing. Because a horizontal movement of the movable window sash 40 to the left is limited by the blank frame 10, the movable window sash 40 moves backward in a perpendicular direction with respect to the length direction of the rail 11a or 11b as illustrated in FIG. 19, thus allowing the movable window sash 40 to uniformly and almost simultaneously press four sides of the seal member 30 integrally mounted on the blank frame 10 or fixed window sash 20 so as to form a plane. Therefore, almost perfect sealing can be provided without causing excessive deformation to the seal member 30 due to a friction.

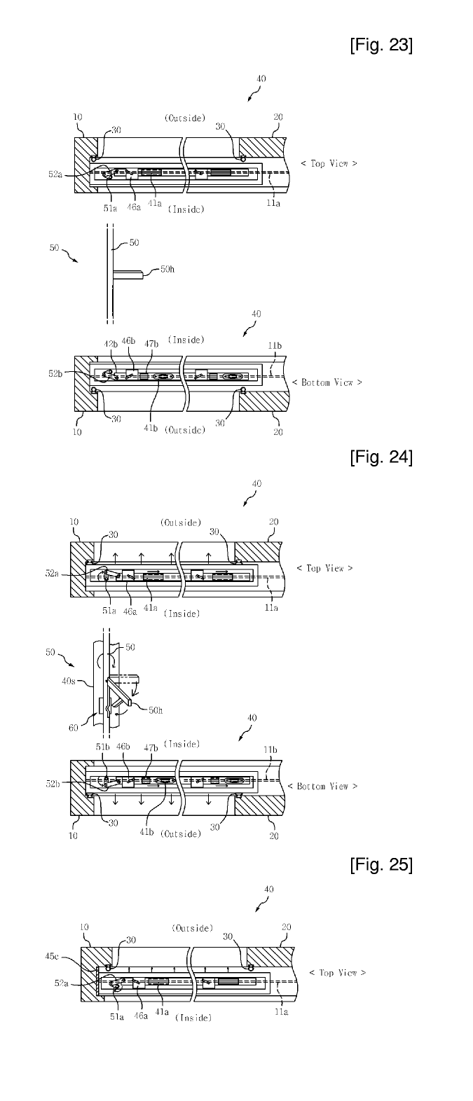

FIG. 23 is top and bottom views respectively illustrating upper and lower structures of the movable window sash 40, and shows a first state before operation of the opening/closing device 50, and FIG. 24 is top and bottom views respectively illustrating upper and lower structures of the movable window sash 40, and shows a second state after operation of the opening/closing device 50.

In particular, FIG. 24 illustrates the opening/closing device 50 with a locking unit 60. Referring to FIG. 24, a protrusion created by folding the rotary handle 50h after rotation of the opening/closing device 50 is used as the locking unit 60. Alternatively, the locking unit 60 may be a mechanical, electrical, or electronic lock having a completely different structure.

The locking unit 60 prevents operation of the opening/closing device 50 in the opposite direction (to unseal the sliding window system, i.e., to separate the movable window sash 40 from the blank frame 10 or seal member 30), thus allowing the movable window sash 40 to uniformly press the seal member 30. Thus, sealing can be ensured even when a significantly large window pressure is exerted on the window.

Meanwhile, referring to FIG. 25, a sheet-type slide bearing 45c is preferably disposed at a boundary between the blank frame 10 and the side frame 40s of the movable window sash 40 in order to eliminate frictional resistance that can be generated therebetween when the movable window sash 40 moves to contact the inside of the blank frame 10 as illustrated in FIGS. 19, 21, 23, and 24.

FIG. 22 illustrates operation of the sliding window system according to the present invention when the rotary handle 50h of the opening/closing device 50 according to the first embodiment is rotated (see a picture on the right) in a state in which the movable window sash slidably moves to an approximately middle position along the bottom rail 11b (see a picture on the left). Because a horizontal movement of the movable window sash 40 parallel with respect to the length direction of the rail 11b is not limited, the movable window sash 40 slides obliquely in the forward and backward direction including a perpendicular displacement component with respect to the length direction of the bottom rail 11b, thus permitting top and bottom sides of four sides of the seal member 30 integrally mounted on the blank frame 10 or the fixed window sash 20 so as to form a plane to be uniformly and almost simultaneously pressed (as illustrated in FIG. 20). This provides almost perfect sealing without causing excessive deformation to the seal member 30 due to a friction while ensuring fixation of the movable window sash 40 to the rails 11a and 11b.

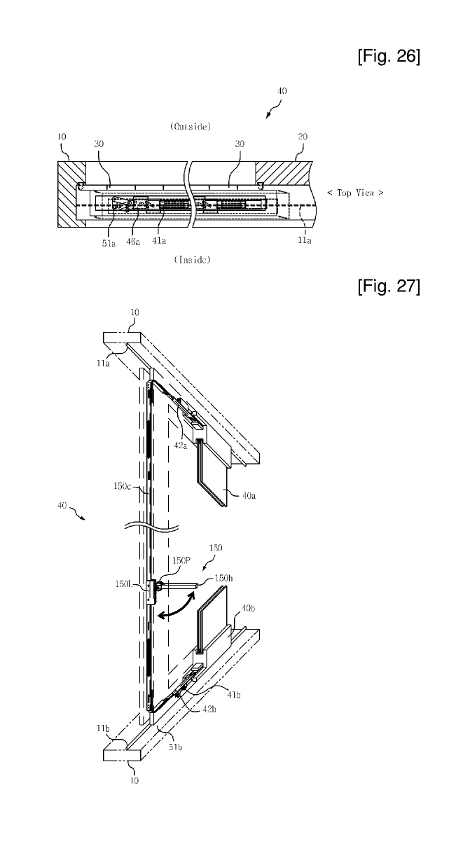

FIG. 26 illustrates operating state of the movable window sash 40 as described above with reference to FIG. 22. When the movable window sash 40 is at a position on the rail 11b not to contact the inside of the blank frame 10, as described above, the locking unit 60 can prevent operation of the opening/closing device 50 in the opposite direction, thus allowing the movable window sash 40 to uniformly press the seal member 30 and to be securely fixed to the rail 11b even when a significantly large window pressure is exerted on the window. Thus, it is possible to prevent the movable window sash 40 from rattling on the rail 11a or 11b within the blank frame in high wind conditions.

FIGS. 23 to 26 illustrate the overall window system having the separation preventing plates 46a and 46b having the same configuration and function as described above with reference to FIGS. 11 and 12.

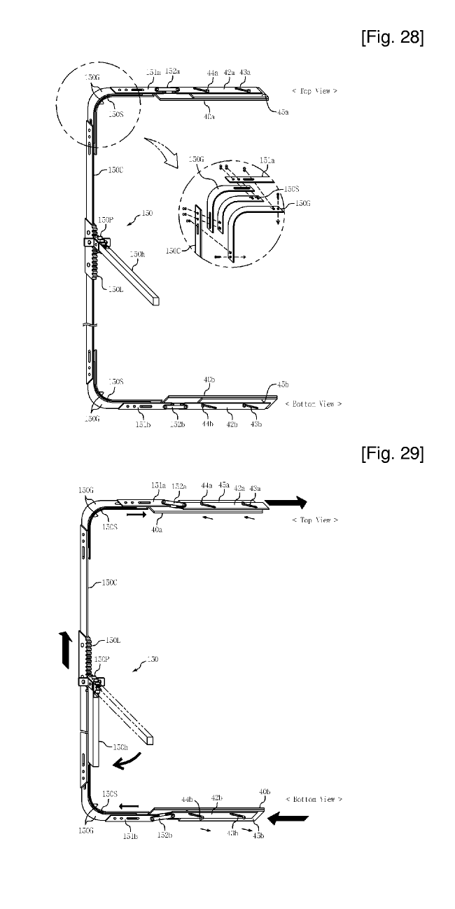

A sliding window system including an opening/closing device with a different structure than the opening/closing device 50 described with reference to FIGS. 14 to 26 according to another embodiment of the present invention (hereinafter referred to as the “second embodiment”) will now be described with reference to FIGS. 27 to 40. FIG. 27 illustrates the overall configuration of a sliding window system having a slidable opening/closing system 150. FIGS. 28 and 29 are perspective view illustrating the configuration and operation of the sliding opening/closing device 150 and an exploded enlarged perspective view of a main portion of the slidable opening/closing device 150.

More specifically, referring to FIGS. 27 to 40, the slidable opening/closing device 150 according to the second embodiment includes a side slide bar 150c mounted along a side frame of the movable window sash 40 to allow up and down movement, a rotary handle 150h applying a force causing the side slide bar 150c to move up and down, a gear set 150L and 150P consisting of a pinion 150P and a rack 150L and converting rotational motion into reciprocating motion (up and down), flexible sliders 150S that are connected to top and bottom of the side slide bar 150c and transmit the reciprocating motion to top and bottom of the movable window sash 40, upper and lower slide bars 151a and 151b mounted on the top and bottom of the movable window sash 40 in a horizontal direction so as to interlock with the flexible sliders 150S, and connecting rods 152a and 152b respectively linked to the bottom plate 42a of the rail guide assembly 41a and 42a and the top plate 42b of the roller assembly 41b and 42b.

Referring to FIGS. 28 and 29 respectively illustrating the states of the slidable opening/closing device 150 before and after the side slide bar 150c slides upward, the slidable opening/closing device 150 operates the gear set 150L and 150P connected to the rotary handle 150h such that the side slide bar 150c can move up or down within the side frame of the movable window sash 40. The flexible sliders 150S mounted within curved guides 150G at top and bottom corners of the movable window sash 40 transmits displacement of the side slide bar 150c in an up-and-down direction to upper and lower slide bars 151a and 151b. Furthermore, the connecting rods 152a and 152b respectively transmit forces including parallel direction components with respect to the length direction of the top and bottom rails 11a and 11b to the bottom plate 42a and the top plate 42b, thus allowing the bottom plate 42a to be pushed away from the side frame of the movable window sash 40 and the top plate 42b to be pulled toward the side frame thereof.

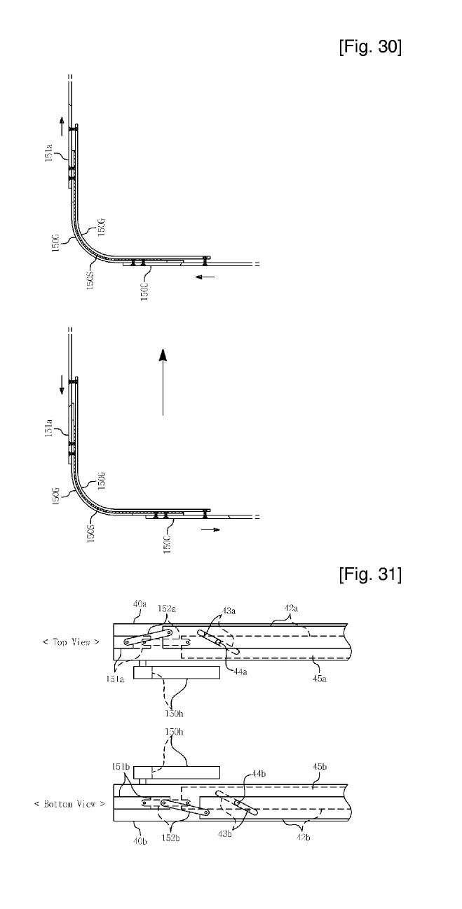

The operation of the slidable opening/closing device 150 in the sliding window system according to the present invention will now be described in more detail with reference to FIGS. 29 and 30. When the rotary handle 150h is rotated in the direction of an arrow in FIG. 29, the pinion 150P and the rack 150L operate to move the side slide bar 150c upward from within the side frame and the flexible slider 150S. As the side slide bar 150c moves upward, a bottom portion of the flexible slider 150S within the curved guide 150G connected to the side slide bar 150c is also pushed upward while a top portion thereof is moved to the right. The upper slide bar 151a connected to the top portion of the flexible slider 150S is also moved to the right as illustrated in FIG. 30. Furthermore, the connecting rod 152a linked to the upper slide bar 151a applies a force to push the bottom plate 42a to the right. At that time, the guide projection 44a projecting out from the upper frame 40a through the sheet-type slide bearing 45a slidably moves along the slant guide hole 43a, thus causing the bottom plate 42a to be obliquely pushed forward to the right.

Meanwhile, because the rail guide 41a in FIG. 27 fixed to the bottom plate 42a is engaged with the top rail 11a in FIG. 27, a displacement in the forward and backward direction is actually constrained not to move the rail guide 41a. Thus, the upper frame 40a of the movable window sash 40 moves obliquely backward to the left, including a component of perpendicular displacement with respect to the length direction of the top rail 11a, as indicated by arrows in FIG. 29.

The operation of a lower structure of the movable window sash 40 will now be described with reference to FIG. 29. As the side slide bar 150c moves upward, the top portion of the flexible slider 150S within the curved guide 150G at the bottom corner of the movable window sash 40 is also pushed upward while the bottom portion thereof is moved to the left. The lower slide bar 151b connected to the bottom portion of the flexible slider 150S is also moved to the left, thus causing the top plate 42b of the roller assembly to be pulled to the left (in the direction of a frame of the movable window sash 40 on which the slidable opening/closing device 150 is mounted) through the connecting rod 152b linked to the lower slide bar 151b. At that time, the guide protrusion 44b projecting out from the lower frame 40b of the movable window sash through the sheet-type slide bearing 45b slidably moves along the slant guide hole 43b, thus causing the top plate 42b of the roller assembly to be obliquely pulled forward to the left.

On the other hand, because the roller 41b in FIG. 27 fixed to the top plate 42b of the roller assembly is engaged with the bottom rail 11b in FIG. 27, a displacement in the forward and backward direction is actually constrained. Thus, as illustrated in a bottom view of FIG. 29, the lower frame 40b of the movable window sash 40 moves obliquely backward to the right as indicated by arrows, including a component of displacement perpendicular to the length direction of the bottom rail 11b.

Of course, the sheet-type slide bearings 45a and 45b that can be optionally adopted minimize friction at boundaries between the upper frame 40a and the bottom plate 42a and between the lower frame 40b and the top plate 42b during the sliding movement.

FIGS. 31 to 34 are top and bottom views of the upper and lower structures of the movable window sash 40. For better understanding, the operating states of the upper and lower structures of the movable window sash 40 will now be described in more detail with reference to FIGS. 31 to 34.

Referring to FIG. 31, when the rotary handle 150h is rotated from solid to dotted line position, the upper slide bar 150a connected to the side slide bar (not shown) and the flexible slider (not shown) move to the right, that is, from the solid to dotted line positions, thus causing the connecting rods 152a and the bottom plate 42a to be pushed to the right. In this case, the guide protrusion 44a projecting out from the upper frame 40a through the sheet-type slide bearing 45a slidably moves along the slant guide hole 43a, thus causing the bottom plate 42a to be obliquely pushed forward to the right as indicated by a dotted line. Unlike the upper slide bar 150a, the lower slide bar 151b is moved to the left from solid to dotted line positions, thus causing the connecting rods 152b and the top plate 42b to be pulled to the left. In this case, the guide protrusion 44b projecting from the lower frame 40b through the sheet-type slide bearing 45b slidably moves along the slant guide hole 43b, thus causing the top plate 42b to be obliquely pulled forward to the left as indicated by a dotted line.

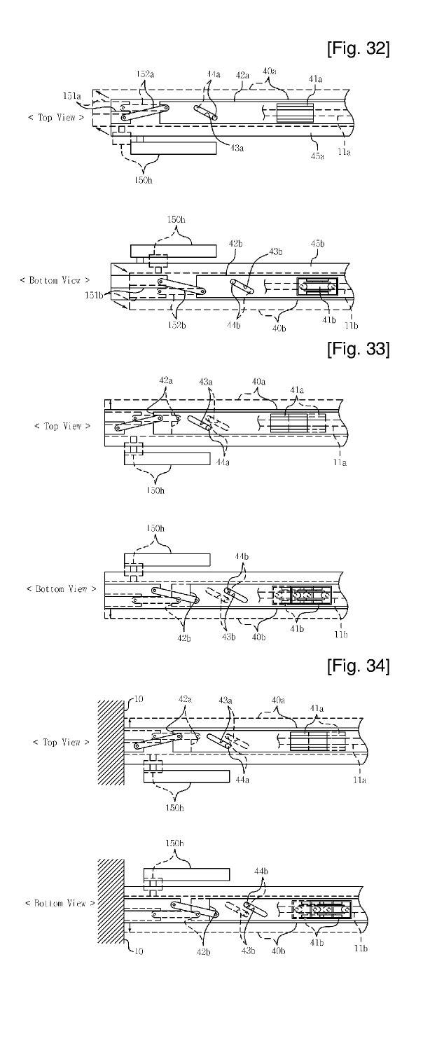

However, because the rail guide 41a fixed to the bottom plate 42a is engaged with the top rail 11a and the roller 41b fixed to the top plate 42b is engaged with the bottom rail 11b, the roller guide assembly 41a and 42a and the roller assembly 41b and 42b cannot move as shown in FIG. 32. A reaction force due to the non-movement is exerted on the upper and lower frames 40a and 40b of the movable window sash 40 so that the upper and lower frames 40a and 40b are respectively moved backward to the left and right (See top and bottom views) in directions indicated by arrows in FIG. 32 (to states indicated by dotted lines). “Backward” refers to upward for the upper frame 40a and downward for the lower frame 40b because they are illustrated in top and bottom views. Despite the above-mentioned description, it is impractical in an actual window system to pull and push the upper and lower frames 40a and 40b of the movable window sash 40 to the left and right as shown in FIG. 32. Since the transverse movement forces applied to the upper and lower frames 40a and 40b in opposite directions with respect to each other are changed into reaction forces, which are exerted on each other so as to move the upper and lower frames 40a and 40b backward in the perpendicular direction with respect to the length direction of the top and bottom rails 11a and 11b. More specifically, although the rail guide 41a and the roller 41b are respectively engaged with the top and bottom rails 11a and 11b within the blank frame 10, only a component of perpendicular displacement with respect to the length direction of the top and bottom rails 11a and 11b is completely constrained. That is, a component of parallel displacement with respect to the length direction thereof is not constrained. As illustrated in a top view of FIG. 33, the movable window sash 40 that can accommodate a perpendicular displacement component with respect to the length direction of the top rail 11a, among displacement components in slant direction generated between guide protrusion 44a and the slant guide hole 43a in the upper structure of the movable window sash 40, moves backward in the direction perpendicular to the length direction of the top rail 11a as indicated by an arrow. At the same time, the rail guide 41a and the rail guide assembly 41a and 42a that can accommodate a parallel displacement component with respect to the length direction of the top rail 11a moves slightly to the right along the top rail 11a. As illustrated in a bottom view of FIG. 33, the movable window sash 40 that can accommodate a perpendicular displacement component with respect to the length direction of the bottom rail 11b, among displacement components in slant direction generated between guide protrusion 44b and the slant guide hole 43b in the lower structures of the movable window sash 40, moves backward in the direction perpendicular to the length direction of the bottom rail 11b as indicated by an arrow. At the same time, the roller 41b and the roller assembly 41b and 42b that can accommodate a parallel displacement component with respect to the length direction of the bottom rail 11b moves slightly to the left along the bottom rail 11a.

When the rotary handle 150h is operated with the side of the movable window sash 40 being in contact with the blank frame 10 as illustrated in FIG. 34, substantially the same operation as illustrated and described with reference to FIG. 33 is performed. The movable window sash 40 that can accommodate a perpendicular displacement component with respect to the length direction of the top rail 11a, among displacement components in slant direction generated between guide protrusion 44a and the slant guide hole 43a, moves backward in the direction perpendicular to the length direction of the top rail 11a. On the other hand, the rail guide 41a that can accommodate a parallel displacement component with respect to the length direction of the top rail 11a moves right along the top rail 11a.

FIGS. 28 to 34 may cause confusion that the top and bottom slant guide holes 43a and 43b will be slant in the same direction. However, the upper structure of the movable window sash 40 is illustrated in a top perspective view and the lower structure is illustrated in a bottom perspective view for better visualization and understanding of the overall configuration and operating structure. Thus, the top and bottom slant guide holes 43a and 43b are bilaterally symmetric to each other, i.e., is slanted in opposite directions, as viewed from above the movable window sash 40.

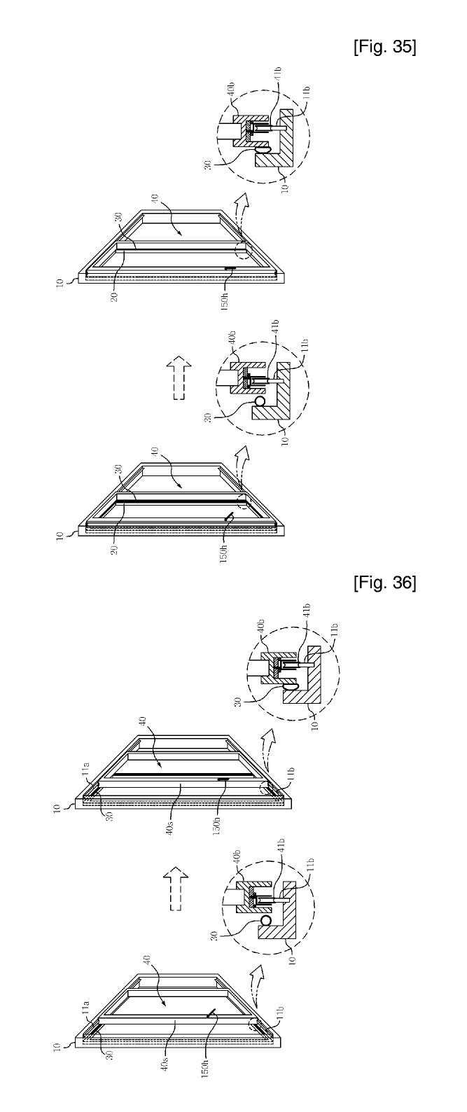

Next, the operation and effect of the opening/closing device according to the second embodiment having the above-mentioned configuration will now be described with reference to FIGS. 35 to 40 in terms of the overall window system.

FIG. 35 illustrates the operation of the sliding window system according the second embodiment to the present invention when the rotary handle 150h of the slidable opening/closing device 150 is rotated (see a picture on the right) in a state in which the movable window sash 40 slidably moves closer to the inside of the blank frame 10 for complete closing.

A horizontal movement of the movable window sash 40 to the left is limited by the blank frame 10 as illustrated in FIG. 34 and transverse movement forces exerted on the upper and lower frames 40a and 40b of the movable window sash 40 are offset against each other to create equilibrium as illustrated in FIG. 33. Consequently, the movable window sash 40 moves backward in a perpendicular direction with respect to the length direction of the top and bottom rails 11a and 11b, thus allowing a frame of the movable window sash 40 to uniformly and almost simultaneously press four sides of the seal member 30 integrally mounted on the blank frame 10 and fixed window sash 20 (or mounted on a rear side of the frame of the movable window sash 40) so as to form a plane. Therefore, almost perfect sealing can be provided without causing excessive deformation to the seal member 30 due to a friction.

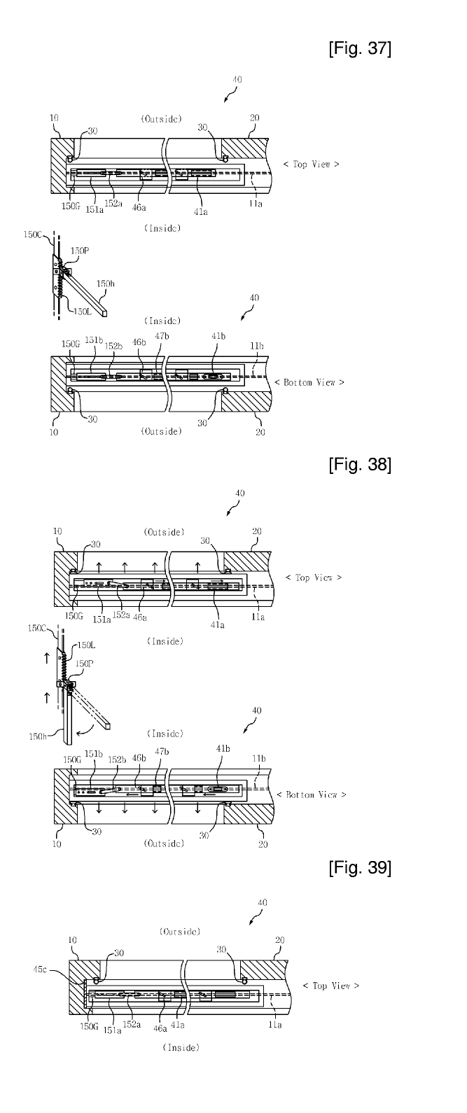

FIG. 37 is top and bottom views respectively illustrating upper and lower structures of the movable window sash 40, and shows a first state before operation of the slidable opening/closing device 150, and FIG. 38 is top and bottom views respectively illustrating upper and lower structures of the movable window sash 40, and shows a second state after operation of the slidable opening/closing device 150. Although not shown in FIGS. 35 to 38, a locking unit may be added to the rotary handle 150h, the pinion 150P, or the rack 150L to maintain a state in which the rotary handle 150h has been rotated as illustrated in FIG. 24. The locking unit allows the movable window sash 40 to uniformly press the seal member 30, thus ensuring sealing even when a significantly large window pressure is exerted on the window.

Preferably, referring to FIG. 39, the sheet-type slide bearing 45c may be disposed at a boundary between the blank frame 10 and the side frame 40s of the movable window sash 40, as described above with reference to FIG. 25.

FIG. 36 illustrates operation of the sliding window system according to the present invention when the rotary handle 150h of the opening/closing device 150 according to the second embodiment is rotated (see a picture on the right) in a state in which the movable window sash 40 slidably moves to an approximately middle position along the bottom rail 11b within the blank frame 10 (see a picture on the left). In this case, a horizontal movement of the movable window sash 40 parallel with respect to the length direction of the rail 11b is not limited but a state of equilibrium is created between transverse movement forces exerted on the upper and lower structures of the movable window sash 40. Thus, the movable window sash 40 moves backward in a perpendicular direction with respect to the length direction of the top and bottom rails 11a and 11b (the rail guide 41a and the roller 41b having parallel displacement components), thus permitting top and bottom sides of four sides of the seal member 30 integrally mounted on the blank frame 10 and the fixed window sash 20 so as to form a plane to be uniformly and almost simultaneously pressed (as described above with reference to FIG. 33).

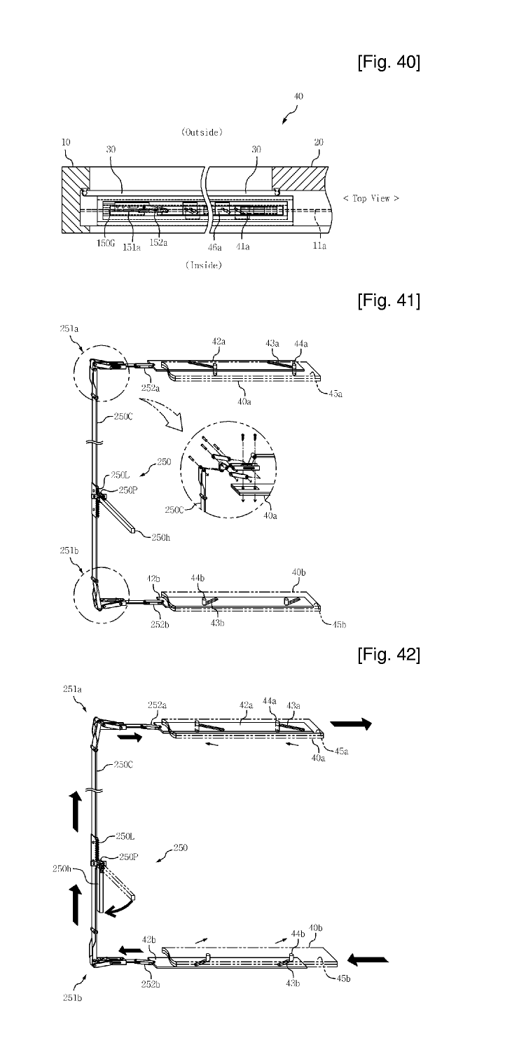

This also provides almost perfect sealing without causing excessive deformation to the seal member 30 due to a friction while ensuring fixation of the movable window sash 40 to the top and bottom rails 11a and 11b. FIG. 40 is a top view illustrating the operation of the sliding window system shown in FIG. 36. When the movable window sash 40 is at a position on the rail 11a not to contact the inside of the blank frame 10, as described above, a locking unit is provided to prevent operation of the opening/closing device 150 in the opposite direction, thus allowing the movable window sash 40 to uniformly press the seal member 30. Thus, sealing can be ensured even when a significantly large window pressure is exerted on the window.

While FIGS. 37 to 40 illustrate the sliding window system including the separation preventing plates 46a and 46b, a detailed description will not be given because they have substantially the same configurations and functions as their counterparts shown in FIGS. 11 and 12.

The present invention also provides an opening/closing device 250 according to another embodiment of the present invention (hereinafter referred to as the ‘third embodiment’) and a sliding window system including the same. The opening/closing device 250 according to the third embodiment is the same as the slidable opening/closing device 150 illustrated in FIGS. 27 to 40 in terms of the overall operation and effect but different in a part of the configuration. The opening/closing device 250 according to the third embodiment will now be described in detail with reference to FIGS. 41 to 43.

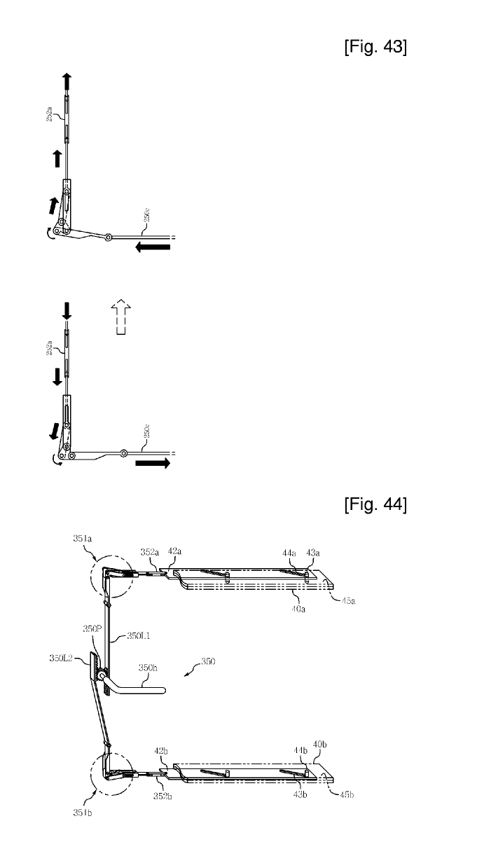

The opening/closing device 250 according to the third embodiment includes a rotary handle 250h mounted along a side of the movable window sash 40, a side slide bar 250c, a gear set 250L and 250P consisting of a pinion 250P and a rack 250L, connecting rods 252a and 252b respectively linked to the bottom plate 42a of the rail guide assembly 41a and 42a and the top plate 42b of the roller assembly 41b and 42b. Unlike in the second embodiment, the opening/closing device 250 has top and bottom jointed link members 251a and 251b mounted at top and bottom corners of the movable window sash 40 and converting up-and-down displacement of the side of the movable window sash 40 into transverse displacement of the upper and lower portions of the movable window sash 40. The top and bottom jointed link members 251a and 251b are mounted at top and bottom corners of the movable window sash 40 as shown in FIG. 41 that is an exploded enlarged perspective view of a main portion of the opening/closing device 250. Referring to FIG. 43 (showing only the top jointed link member 251a), as the side slide bar 250c is pushed to the left, the top jointed link member 251a transmits a force to push the connecting rod 252a connected thereto. On the other hand, as the side slide bar 250c is pulled to the right, the top jointed link member 251a transmits a force to pull the connecting rod 252a toward the bottom corner of the movable window sash 40. In terms of the overall sliding window system, the opening/closing device 250 having the top and bottom jointed link members 251a and 251b has substantially the same function as the slidable opening/closing device 150 with the curved guide 150G and the flexible sliders 150S according to the above-mention second examination. Thus, referring to FIGS. 41 and 42, the opening/closing device 250 show substantially the same states before and after the side slide bar 250c slides upward as shown in FIGS. 28 and 29. Although FIGS. 41 and 42 show that the slant guide hole 43b is slanted and moved in different directions from that in FIGS. 28 and 29, this is because FIGS. 41 and 42 illustrate the lower structure of the movable window sash 40 in a top perspective view unlike FIGS. 28 and 29 illustrating the lower structure in a bottom perspective view. That is, the slant guide hole 43b shown in FIGS. 41 and 42 are actually slant and moved in the same direction as the slant guide hole 43b shown in FIGS. 28 and 29. Thus, movement of the movable window sash 40 along the rails 11a and 11b within the blank frame 10 and the operating principle and process for the movable window sash 40 coming into contact with the seal member 30 are as shown and described with reference to FIGS. 31 to 40.

FIGS. 44 and 45 illustrate an opening/closing device 350 according to another embodiment of the present invention (hereinafter referred to as the ‘fourth embodiment’). Unlike the opening/closing device 250 according to the third embodiment having the above-described configuration, the opening/closing device 350 according to the fourth embodiment has first and second side slide bars 350L1 and 350L2 mounted along the side frame of the movable window sash. Rack gears respectively mounted on the first and second side slide bars 350L1 and 350L2 mesh with a pinion 350P connected to a rotary handle 150h when they are located at a symmetrical position with respect to the pinion 350P. Referring to FIG. 45, when the rotary handle 150h is rotated as indicated by an arrow, the first side slide bar 350L1 is pushed upward while the second side slide bar 350L2 is pushed downward so as to push the bottom plate 42a positioned on the upper frame 40a of the movable window sash 40 and the top plate 42b positioned under the lower frame 40b thereof. However, because the rail guide (not shown) and the roller (not shown) formed to the bottom plate 42a and the top plate 42b, respectively, are constrained to ride on the top and bottom rails 11a and 11b, the upper and lower frames 40a and 40b of the movable window sash 40 have transverse displacement in the same slant direction (i.e., move backward to the left as indicated by arrows). Thus, the overall sliding window system including the opening/closing device 350 operates in the same manner as described with reference to the first embodiment. The slant guide holes 43a and 43b are slanted in the same direction. Since the overall sliding window system has the same configuration and functions as that shown in FIGS. 15 to 26 except the structure of the opening/closing device 350, a detailed description thereof will be omitted to avoid redundancy.

FIG. 46 illustrates an opening/closing device 50 according to another embodiment of the present invention (hereinafter referred to as the “fifth embodiment”). Referring to FIG. 46, unlike in the opening/closing device 50 according to the first embodiment, connecting rods 52a and 52b are linked at symmetric positions to the rotating end members 51a′ and 51b′ fixed to the rotating axis member 50c. Thus, as the rotating axis member 50c rotates due to the rotation of the rotary handle 50h, the bottom plate 42a of the rail guide assembly and the top plate 42b of the roller assembly move transversely in opposite slant directions as indicated by arrows (in the same direction as illustrated in FIG. 29). The overall sliding window system having the above-mentioned structure operates in the same manner as the sliding window system having the opening/closing device 150 of the second embodiment. Furthermore, like in the second embodiment, the slant guide holes 43a and 43b are slanted in opposite directions. While FIG. 21 shows the slant guide holes 43a and 43b are slanted in the same direction, they are actually slant in opposite directions because the lower structure of the movable window sash is illustrated in a bottom perspective view. Since the overall sliding window system has the same configuration and functions as that shown in FIGS. 31 to 40 except for the structure of the opening/closing device 50, a detailed description thereof will be omitted to avoid redundancy.

FIGS. 47 and 48 respectively show opening/closing devices 50 and according to sixth and seventh embodiments of the present invention. More specifically, FIG. 47 shows a modified example of the opening/closing device 50 according to the first embodiment of the present invention. Referring to FIG. 47, the opening/closing device 50 includes pinion gears 53a and 53b respectively mounted on the top and bottom of the rotating axis member 50c and rack gears 54a and 54b respectively mounted to the bottom plate 42a of the rail guide assembly and the top plate 42b of the roller assembly and meshing with the pinion gears 53a and 53b so that they move in the same slant direction when viewed from the plane of the movable window sash. Thus, as the rotating axis member 50c rotates due to the rotation of the rotary handle 50h, the bottom plate 42a of the rail guide assembly and the top plate 42b of the roller assembly move transversely in the same slant direction indicated by arrows. That is, the opening/closing device 50 according to the present embodiment has substantially the same structure as illustrated in FIGS. 16 and 45. Thus, the overall sliding window system including the opening/closing device 350 operates in the same manner as described with reference to the first embodiment. The slant guide holes 43a and 43b are slanted in the same direction. While FIG. 47 shows the slant guide holes 43a and 43b are slanted in different directions, they are actually slant in the same direction because the lower structure of the movable window sash is illustrated in a bottom perspective view. Since the overall sliding window system has the same configuration and functions as that shown in FIGS. 17 to 26 except for the structure of the opening/closing device 50, a detailed description thereof will be omitted to avoid redundancy.

FIG. 48 shows a modified example of the opening/closing device 50 of FIG. 47. The opening/closing device 50 according to the seventh embodiment has a structure modified so as to operate in the same manner as the opening/closing device 50 of the fifth embodiment shown in FIG. 46. That is, the upper structure of the movable window sash is bilaterally symmetric to the lower structure as shown in FIG. 46 so that the upper frame 40a of the movable window sash is pushed but the lower frame 40b is pulled. The opening/closing device 50 includes pinion gears 53a and 53b mounted on the top and bottom of the rotating axis member 50c and rack gears 54a′ and 54b′ respectively mounted to the bottom plate 42a of the rail guide assembly and the top plate 42b of the roller assembly and meshing with pinion gears 53a and 53b so that they move in the same direction (front/rear direction) but in opposite slant directions (transverse direction) when viewed from the plane of the movable window sash. Thus, as the rotating axis member 50c rotates due to the rotation of the rotary handle 50h, the bottom plate 42a of the rail guide assembly and the top plate 42b of the roller assembly move transversely in the opposite slant directions as indicated by arrows. That is, the opening/closing device 50 according to the present embodiment has substantially the same structure as illustrated in FIGS. 29 and 46. Thus, the overall sliding window system including the opening/closing device 50 operates in the same manner as described with reference to the second embodiment. The slant guide holes 43a and 43b are bilaterally symmetric to each other, i.e., slant in the opposite directions. While FIG. 48 shows the slant guide holes 43a and 43b are slanted in the same direction, they are actually slant in the opposite directions because the lower structure of the movable window sash is illustrated in a bottom perspective view. Since the overall sliding window system has the same configuration and functions as that shown in FIGS. 31 to 40 except for the structure of the opening/closing device 50, a detailed description thereof will be omitted to avoid redundancy.

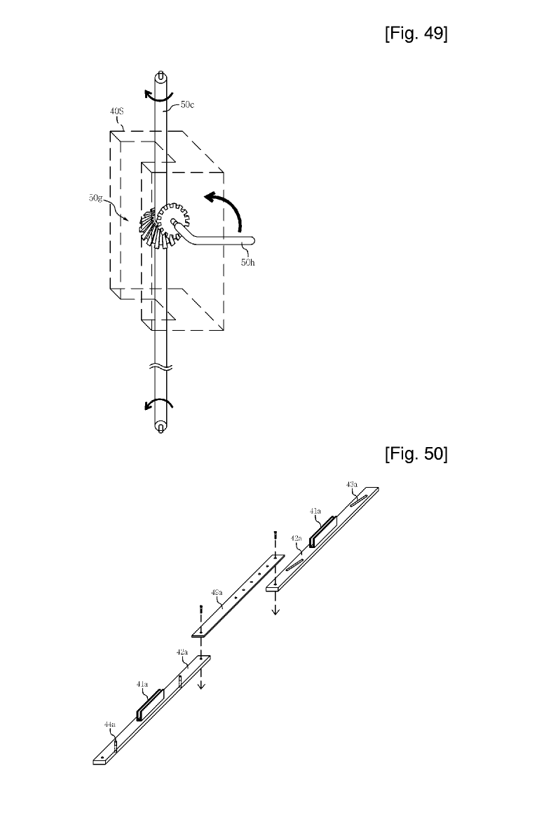

Among the opening/closing devices of the above-mention various examinations, the opening/closing devices having the rotary handles 50h and rotating axis members 50c may, as shown in FIG. 49, further include a conversion gear set 50g such as a bevel gear set that is mounted within the side frame 40s of the movable window sash between the rotary handle 50h and the rotating axis member 50c and converts one rotational force to another. In this case, the rotary handle 50h can be installed in a direction for saving the installation space, for facilitating its use, and for improving safety. Such a conversion gear set may be used in the opening/closing devices having side slide bars 150c and 250c according to the other embodiments thereof (exemplified drawings being omitted).

Furthermore, the opening/closing devices according to the first through seventh embodiments of the present invention are summarized in Table 1. The opening/closing devices can be any type of devices that can respectively apply movement forces of parallel directions with respect to the length direction of the bottom and top rails 11b and 11a to the top plate 42b of the roller assembly mounted under the lower frame 40b of the movable window sash 40 and the bottom plate 42a of the rail guide assembly positioned on the upper frame 40a thereof.

TABLE 1

| | | | Direction of slant |
|---|---|---|---|
| | | | guide holes in |
| | | Main reference | upper/lower |
| Embodiment | Related drawings | numerals | structures |
| First | FIGS. 14 to 26 | 50(50c, 51a, 52a) | Same |
| Second | FIGS. 27 to 40 | 150(150P, 150L, | Opposite |
| | | 150S) | |
| Third | FIGS., 41 to 43 | 250(250P, 250L, | Opposite |
| | | 251a) | |
| Fourth | FIGS. 44 and 45 | 350(350L1, 350L2) | Same |
| Fifth | FIG. 46 | 50(50c, 51a′, 52a) | Opposite |
| Sixth | FIG. 47 | 50(50c, 53a, 54a) | Same |
| Seventh | FIG. 48 | 50(50c, 53a, 54a′) | Opposite |

While FIGS. 14 to 48 show that the sheet-type slide bearings 45a and 45b are mostly used as a lubricant member, as above-described, the sheet-type slide bearings 45a and 45b are optional depending on the load of the movable window sash 40 and frictional state at a boundary that may vary depending on the type of material used. Other equivalents to a lubricant member such as a ball bearing may also be used for performing a lubricating function.

Among main elements of the apparatus for opening/closing a window in a sliding window system according to the present invention, one movable window sash may include one or the more rail guide assemblies 41a and 42a and one or the more roller assemblies 41b and 42b although FIGS. 14 to 48 show that the apparatus includes one rail guide assembly 41a and 42a and one roller assembly 41b and 42b. When the apparatus includes a plurality of rail guide assemblies (refer to “41a” and “42a”) and a plurality of roller assemblies (refer to “41b” and “42b”), the plurality of rail guide assemblies (refer to “41a” and “42a”) having a predetermined length and the plurality of roller assemblies (refer to “41b” and “42b”) having a predetermined length may respectively be connected to one another. Referring to FIG. 50, length-adjustable intermediate connecting members 49a are inserted into a plurality of corresponding connecting holes to connect between the bottom plates 42a of the plurality of rail guide assemblies 41a and 42a, thus allowing high-volume production and easy assembly.

While FIG. 50 only shows that the intermediate connecting members 49a are used to connect the rail guide assemblies 41a and 42a to one another, the roller assemblies 41b and 42b may be connected to one another by means of the intermediate connecting members 49a. Furthermore, the guide protrusion 44a is formed to the bottom plate 42a of the rail guide assembly 41a and 42a on the left (the slant guide hole 43a being formed on the upper frame 40a of the movable window sash 40) while the slant guide hole 43a is formed to the bottom plate 42a of the rail guide assembly 41a and 42a on the right (the guide protrusion 44a being formed on the upper frame 40a of the movable window sash 40). In this manner, the slant guide hole 43a and the guide protrusion 44a may be selectively respectively formed to the upper frame 40a of the movable window sash 40 and the bottom plate 42a of the rail guide assembly. Similarly, the slant guide hole 43b the guide protrusion 44b may be selectively respectively formed to the lower frame 40b of the movable window sash 40 and the top plate 42b of the roller assembly.

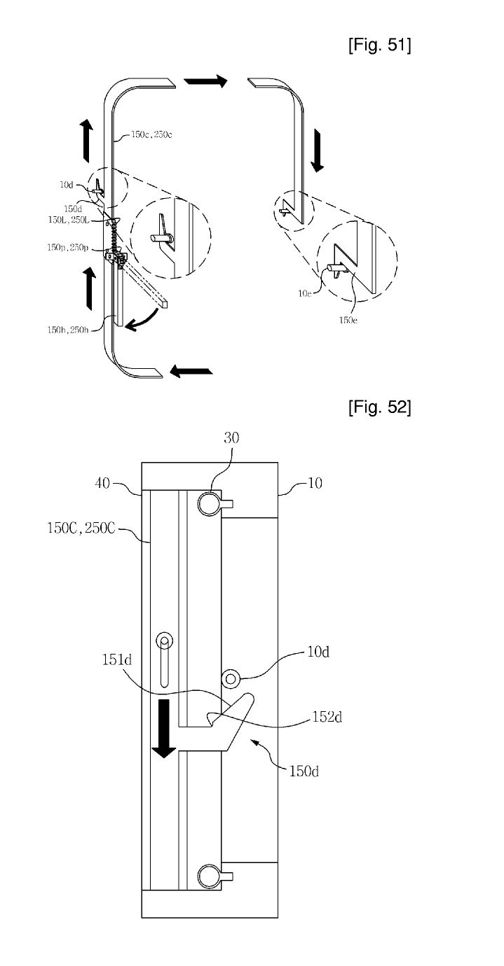

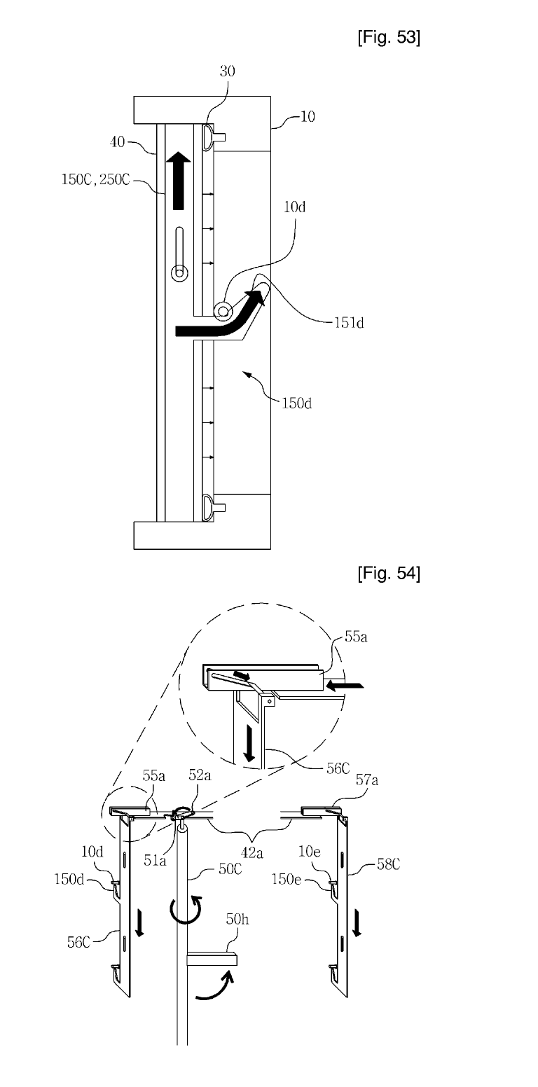

While FIG. 24 shows that the locking unit 60 is separately provided to prevent operation of the opening/closing device 50 in opposite direction, other types of locking units 10d and 150d may be used as illustrated in FIGS. 51 to 55. Referring to FIG. 51, in the slidable opening/closing device 150 (250), the rotary handle 150h (250h) is rotated so as to rotate the pinion 150P (250P) connected thereto and move upward the side slide bar 150c (250c) having the rack 150L (250L) meshing with the pinion 150P (250P) mounted thereon. When a hook 150d is formed on one side of the side slide bar 150c (250c) and a stop lug 10d is located within the blank frame 10 or the movable window sash, the hook 150d on the side slide bar 150c (250c) being pushed upward is fixed to the stop lug 10d by a large friction force, thus maintaining a sealing state even though an external force such as wind pressure is exerted on the movable window sash, unless the rotary handle 150h (250h) forcibly rotates in the opposite direction. In particular, when the stop lug 10d is formed on the blank frame 10 as shown in FIGS. 52 and 53, an slant surface 151d and a stopper 152d are formed on the inside of the hook 150d. Thus, as the rotary handle 150h (250h) of the slidable opening/closing device 150 (250) rotates to move upward the side slide bar 150c (250c) connected to the rotary handle 150h (250h) while moving the movable window sash 40 backward in the direction of the blank frame 10, the slant surface 151d is enclosingly engaged with the stop lug 10d to guide the movable window sash 40 so that it moves toward the blank frame 10 in such a way as to properly press the seal member 30. That is, the movable window sash 40 slidably moves close to the blank frame 10 or the fixed window sash 20 in a front or rear direction so as to press the seal member 30 for effecting a seal between either the blank frame 10 or fixed window sash 20 and the movable window sash 40. At the same time, the hook 150d formed on the side slide bar 150c as a locking unit to move up or down is engaged with the stop lug 10d formed on the blank frame 10 as a locking unit to maintain a state in which the seal member 30 is pressed.

Furthermore, in the case where the seal member 30 completely ceases to be pressed, the stop lug 10d is rigidly hooked in the stopper 152d formed at an end of the slant surface 151a, thus ensuring complete fixation at a side of the movable window sash 40 even though a large elastic repulsive force of the seal member 30 is applied to push the movable window sash 10 back to its original position or a wind pressure is exerted by a strong wind on the movable window sash 40.

More preferably, a hook 150e is further formed at a second portion of the movable window sash 40, the second portion is located on an opposite side to the side frame along which the side slide bar 150c is mounted, and a stop lug 10e is further formed at a position on the opposite side corresponding to the stop lug 10d, as shown in a picture on the right of FIG. 51. When the movable window sash 40 is sealed, the hook 150e is hooked and fixed to the stop lug 10d by a large friction force, thus achieving a balance between sealing effects on the left and right sides of the movable window sash 40.

While the locking units 150d and 10d, and 150e and 10e as described above with reference to FIGS. 51 to 53 can be applied to opening/closing devices according to embodiments of the present invention, having the side slide bar 150c (250c) on the side of the movable window sash 40, they may be difficult to apply to opening/closing devices using the rotating axis member 50c according to embodiments of the present invention due to structural differences.

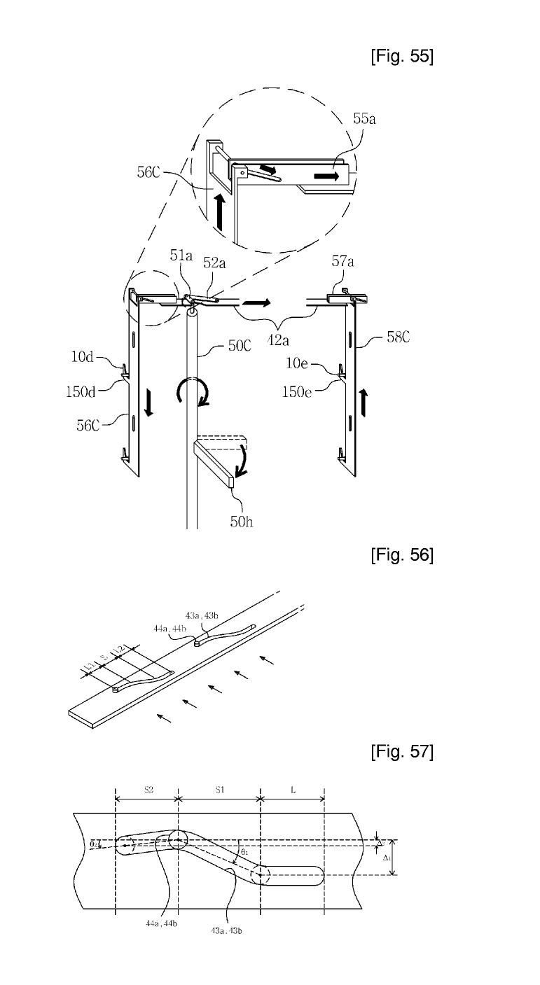

To solve this problem, the present invention provides an opening/closing device according to another embodiment of the present invention. Referring to FIGS. 54 and 55, the opening/closing device according to the present embodiment further includes conversion guide members 55a and 57a. The conversion guide members 55a and 57a connect the bottom plate 42a of the rail guide assembly, which transversely moves in a parallel direction with respect to the length direction of the top rail 11a as the rotary handle 50h formed to the rotating axis member 50c mounted longitudinally on the movable window sash (not shown) rotates, to side slide bars 56C and 58C additionally mounted on the side of the movable window sash, so as to convert transverse displacement of the bottom plate 42a into up-and-down displacement of the side slide bars 56C and 58C. Hooks 150d and 150e formed to the side slide bars 56C and 58C are hooked to stop lugs 10d and 10e formed on the blank frame 10, like in the embodiment illustrated in FIG. 51. Although not shown in detail, each of the hooks 150d and 150e preferably has an slant surface 151d and a stopper 152d formed on the inside thereof, as illustrated in FIGS. 52 and 53.

Furthermore, if a stop lug is formed on a side slide bar of a movable window sash and a corresponding hook is formed on a blank frame (exemplified drawings being not given) unlike in FIGS. 51 to 55, the same operating performance as described above can be achieved.

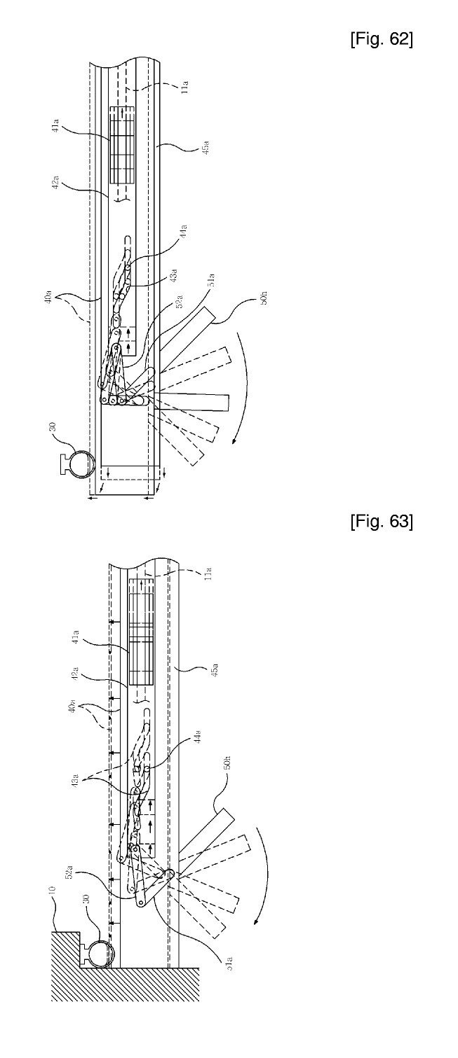

While the drawings listed above show the slant guide holes 43a and 43b has an approximately linear shape, they may have a circular-arc shape of a fixed or variable curvature. FIG. 56 shows an slant guide hole 43a or 43b according to an embodiment of the present invention. FIGS. 61 and 62 respectively show the operating states of the opening/closing device when the movable window sash 40 contacts the blank frame 10 and is at any position on the rail 11a not to contact it. Referring to FIG. 56, each of slant guide holes 43a and 43b has three sections, i.e., a central slant section S slant with respect to the length direction of the top or bottom rail 11a or 11b and two parallel linear sections L1 and L2 disposed on either side of the central slant section S in parallel with respect to the length direction of the top or bottom rail 11a or 11b. In particular, the parallel linear sections L1 and L2 may act as a locking unit. More specifically, when forward or backward movement of the movable window sash 40 for sealing is completed, the guide protrusions 44a and 44b are located at the parallel linear sections L1 and L2 as illustrated in FIGS. 61 and 62. At that time, the parallel linear sections L1 and L2 are provided to ensure fixation of the movable window sash (i.e., upper frame 40a) onto the rail 11a or 12b by preventing the movable window sash from rattling in a front or rear direction even in the case where an elastic repulsive force of the seal member 30 or an external force such as a large wind force is applied to the movable window sash, except in the case where the rotary handle 50h operates in the opposite direction (i.e., a force is applied to the rotary handle 50h in a parallel direction with respect to the length direction of the rail 11a or 11b).

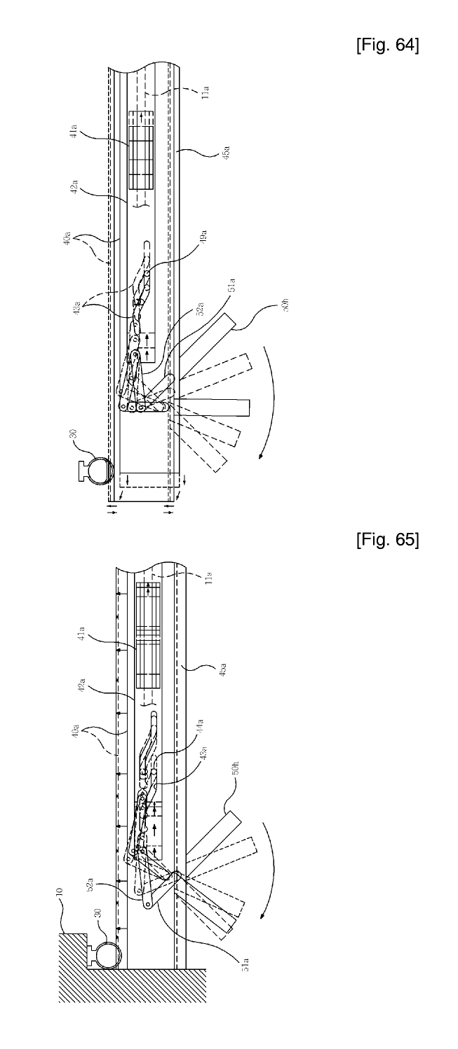

While FIG. 56 shows that the parallel linear sections L1 and L2 are disposed on both sides of the central slant section S, a parallel linear section may be disposed on only one side thereof. FIG. 57 shows an slant guide hole 43a or 44a according to another embodiment of the present invention. FIGS. 63 and 64 respectively show the operating states of the opening/closing device when the movable window sash contacts the blank frame and is at any position on the rail 11a not to contact it. Referring to FIG. 57, each of the slant guide holes 43a and 44a may have two slant sections, i.e., a central first slant section S1 slant at an angle θ1 and a second slant section S2 slant at an angle θ2 in the opposite direction to the first slant section S1. More specifically, the slant guide hole 43a is configured as shown in FIG. 57 such that the movable window sash (i.e., the upper frame 40a) can be returned by accommodating an elastic repulsive force due to the seal member 30 when the guide protrusion 44a moves along the slant guide hole 43a to reach a position (i.e., the left side of the slant guide hole 43a) as the rotary handle 50h is further rotated past a position where the seal member 30 is pressed at a maximum pressure, as illustrated in FIGS. 63 and 64. In this case, the angle of inclination and the length of each section is preferably adjusted such that a width Δ2 of movement of the guide protrusion 44a or 44b along the second slant section S2 in a perpendicular direction with respect to the length direction of the rail 11a is less than a width Δ1 of movement of the guide protrusion 44a or 44b along the first slant section S1 in the same direction to maintain a sealing state provided by the seal member 30.

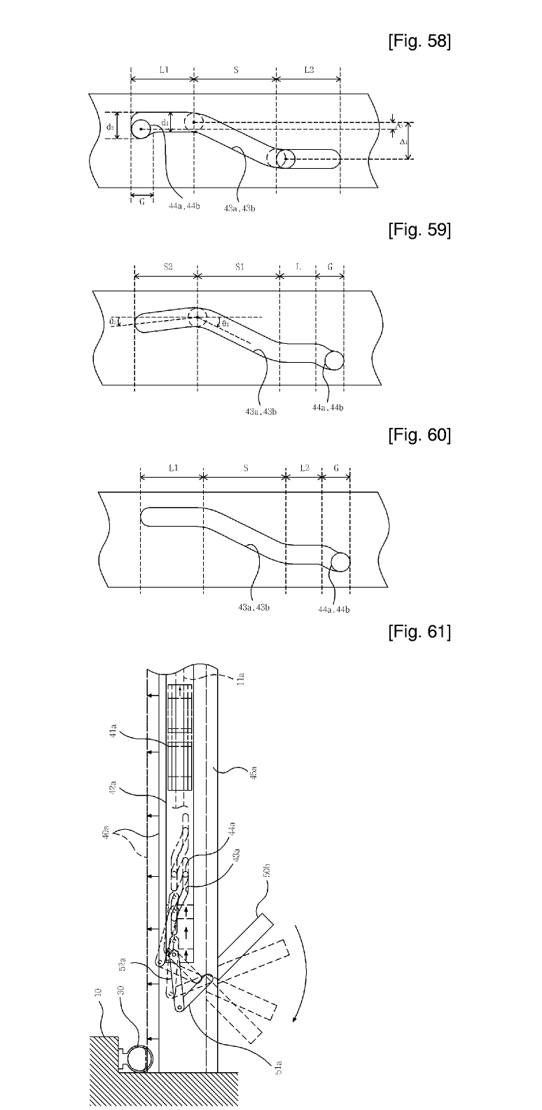

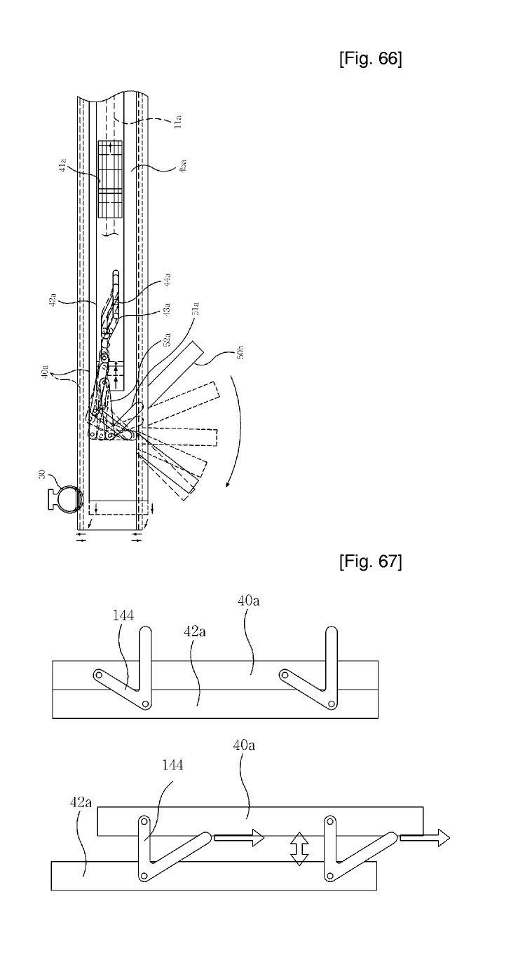

FIG. 58 shows a modified example of the slant guide hole 43a or 43b of FIG. 56. FIGS. 65 and 66 respectively show the operating states of the opening/closing device when the movable window sash contacts the blank frame and is at any position on the rail 11a not to contact it. In the same manner as described above with reference to FIGS. 63 and 64, the movable window sash (i.e., the upper frame 40a) is returned by accommodating an elastic repulsive force due to the seal member 30 when the guide protrusion 44a moves along the slant guide hole 43a to reach a position (i.e., the left end of the slant guide hole 43a as the rotary handle 50h is further rotated past a position where the seal member 30 is pressed at a maximum pressure. To achieve this operation, referring to FIG. 58, a stopping groove G having a diameter d2 greater than a diameter d1 of the guide protrusion 44a or 44b is formed in a first parallel linear section L1 extending from one side of a central slant section S. In this case, the depth of the stopping groove G is preferably adjusted to maintain a sealing state provided by the seal member 30. To maintain the sealing state, a width Δ2 of movement of the guide protrusion 44a or 44b, which is generated in a perpendicular direction with respect to the length direction of the rail 11a as an elastic repulsive force of the seal member 30 fits the guide protrusion 44a or 44b into the stopping groove G (as shown in FIGS. 65 and 66), is less than a width Δ1 of movement of the guide protrusion 44a or 44b along the central slant section S in the same direction.

Using the slant guide hole 43a or 43b shown in FIGS. 57 and 58 allows a user to recognize a change from an open state to a closed state of the movable window sash by sensing a reduced compressive strength being transferred as the rotary handle 50h rotates past a position where the seal member 30 is pressed at a maximum pressure when the movable window sash is closed so that the upper frame 40a (illustrated in a top view) of the movable window sash becomes contiguous to the seal member 30.

While FIGS. 61 to 66 show rotating axis-type opening/closing devices according to the embodiments of the present invention including the rotary handle 50h, the rotating end member 51a, and the connecting rods 52 for explaining the operation of the slant guide hole 43a or 43b shown in FIGS. 56 and 58, the slant guide hole 43a or 43b may operate in the same manner as above when it is applied to opening/closing devices having a different structure than the rotating axis-type opening/closing devices

FIGS. 59 and 60 illustrate modified examples of the slant guide holes 43a or 43b of FIGS. 56 and 57. Referring to FIGS. 59 and 60, the slant guide hole 43a or 43b may further have a stopping groove G at an end of a parallel linear section L or L2 located at the right side of the central slant section S1 or S. Furthermore, other various types of slant guide holes can be provided by combining the various types of slant guide holes 43a or 43b described above.

While in the above description, the sheet-type slide bearings 45a and 45b are mostly used a lubricant member, as described above, the sheet-type slide bearings 45a and 45b are optional depending on the load of the movable window sash 40 and frictional state at a boundary that may vary depending on the type of material used. Other equivalents to a lubricant member such as a ball bearing may also be used for performing a lubricating function.

While in the above description, slant guide holes are engaged with guide protrusions to connect between a lower frame of a movable window sash and a roller assembly and between an upper frame of the movable window sash and a rail guide assembly, an eccentric link bar connecting structure such as an eccentric rotating link bar 144 shown in FIG. 67 may be used to connect the bottom plate 42a of the rail guide assembly to a top surface of the upper frame 40a of the movable window sash. The same structure can be used to connect the top plate 42b of the roller assembly to a top surface of the lower frame 40b.

While the present invention has been particularly shown and described with reference to embodiments thereof, it will be understood by those of ordinary skill in the art that various changes and modifications in form and details may be made without departing from the spirit and scope of the present invention as defined by the following claims and their equivalents.

1-93. (canceled)

94. An apparatus for opening/closing a window in a sliding window system including a sliding window or sliding door, the apparatus comprising:
a roller assembly and a rail guide assembly mounted such that a movable window slidably moves along top and bottom rails fixed to a frame for opening and closing;
a movable window sash that fixedly supports a glass pane or panel, and that comprises an upper frame separated from the rail guide assembly and mounted under the rail guide assembly and a lower frame separated from the roller assembly and mounted on the roller assembly;
connecting members for connecting between the separated upper frame and rail guide assembly and between the lower frame and the roller assembly; and
an opening/closing device that is mounted on the movable window sash, and that applies a movement force including a direction component parallel with respect to the length direction of the top and bottom rails to the rail guide assembly and the roller assembly at any position on the top and bottom rails in order to generate a relative displacement in the connecting members, the relative displacement including a component of displacement perpendicular with respect to the length direction of the top and bottom rails.

95. The apparatus of claim 94, wherein:
each of the connecting members consists of at least one inclined guide hole and at least one guide protrusion; and
the opening/closing device applies the movement force to the rail guide assembly and the roller assembly, in order to generate the relative displacement between the at least one inclined guide hole and the at least one guide protrusion.

96. The apparatus of claim 95, wherein:
the at least one inclined guide hole for connecting between the lower frame of the movable window sash and the roller assembly is formed to a top plate of the roller assembly, and
the at least one guide protrusion projects downward from the lower frame of the movable window sash and is fitted into the at least one inclined guide hole to allow slidable movement in an inclined direction.

97. The apparatus of claim 95, wherein:
the at least one inclined guide hole for connecting between the upper frame of the movable window sash and the rail guide assembly is formed to a bottom plate of the rail guide assembly; and
the at least one guide protrusion projects upward from the upper frame of the movable window sash and is fitted into the at least one inclined guide hole to allow slidable movement in an inclined direction.

98. The apparatus of claim 95, wherein:
the at least one inclined guide hole for connecting between the lower frame of the movable window sash and the roller assembly is formed in the lower frame of the movable window sash; and
the at least one guide protrusion projects upward from the top plate of the roller assembly and is fitted into the at least one inclined guide hole to allow slidable movement in an inclined direction.

99. The apparatus of claim 95, wherein:
the at least one inclined guide hole for connecting between the upper frame of the movable window sash and the rail guide assembly is formed in the upper frame of the movable window sash; and
the at least one guide protrusion projects downward from the bottom plate of the rail guide assembly and is fitted into the at least one inclined guide hole to allow slidable movement in an inclined direction.

100. The apparatus of claim 95, wherein:
the opening/closing device respectively applies a movement force of the same transverse direction to the roller assembly and the rail guide assembly in upper and lower structures of the movable window sash; and
the at least one inclined guide hole respectively formed in the upper and lower structures of the movable window sash are inclined in the same direction to each other when viewed from a plane of the movable window sash.

101. The apparatus of claim 95, wherein:
the opening/closing device applies a movement force to the roller assembly and the rail guide assembly in laterally opposite directions; and
the at least one inclined guide hole respectively formed in the upper and lower structures of the movable window sash are inclined in opposite directions that are bilaterally symmetric to each other when viewed from a plane of the movable window sash.

102. The apparatus of claim 100, wherein the opening/closing device comprises:
a rotating axis member that has a rotary handle and that is mounted along a longitudinal direction of a side frame of the movable window sash;
connecting rods that are respectively linked to the top plate of the roller assembly and the bottom plate of the rail guide assembly and transform rotational motion of the rotating axis member into reciprocating motion of the upper and lower structures of the movable window sash; and
rotating end members that are respectively fitted to the top and bottom of the rotating axis member such that the connecting rods push or pull the top plate of the roller assembly and the bottom plate of the rail guide assembly due to rotation of the rotating axis member to simultaneously move in a parallel direction with respect to the top and bottom rails, each rotating end member having one end fixed to the same position on either top or bottom of the rotary axis member and the other end linked to either of the connecting rods.

103. The apparatus of claim 101, wherein the opening/closing device comprises:
a rotating axis member that has a rotary handle and that is mounted along a longitudinal direction of a side frame of the movable window sash;
connecting rods that are respectively linked to the top plate of the roller assembly and the bottom plate of the rail guide assembly and transform rotational motion of the rotating axis member into reciprocating motion of the upper and lower structures of the movable window sash; and
rotating end members that are respectively fitted to the top and bottom of the rotating axis member such that the connecting rods push or pull the top plate of the roller assembly and the bottom plate of the rail guide assembly due to rotation of the rotating axis member to simultaneously move in opposite directions including a parallel displacement component with respect to the top and bottom rails, each rotating end member having one end fixed to a symmetrically opposite position on either top or bottom of the rotary axis member and the other end linked to either of the connecting rods.

104. The apparatus of claim 101, wherein the opening/closing device comprises:
a side slide bar mounted along a longitudinal direction of a side frame of the movable window sash to allow up and down movement;
a rotary handle for applying a force causing the side slide bar to move up and down;
a gear set for converting rotational motion of the rotary handle into up-and-down reciprocating motion of the side slide bar;
flexible sliders that are connected to top and bottom of the side slide bar and transmit the reciprocating motion to top and bottom of the movable window sash;
upper and lower slide bars mounted on the top and bottom of the movable window sash in a horizontal direction so as to interlock with the flexible sliders; and
connecting rods respectively linking the upper and lower slide bars to the bottom plate of the rail guide assembly and the top plate of the roller assembly.

105. The apparatus of claim 101, wherein the opening/closing device comprises:
a side slide bar mounted along a longitudinal direction of a side frame of the movable window sash to allow up and down movement;
a rotary handle for applying a force causing the side slide bar to move up and down;
a gear set for converting rotational motion of the rotary handle into up-and-down reciprocating motion of the side slide bar;
jointed link members that are mounted at top and bottom corners of the movable window sash and convert up-and-down displacement of the side slide bar into transverse displacement of the upper and lower structures of the movable window sash for transmission; and
connecting rods respectively linking the jointed link members to the bottom plate of the rail guide assembly and the top plate of the roller assembly.

106. The apparatus of claim 95, wherein the at least one inclined guide hole comprises:
a central inclined section inclined with respect to the length direction of the top or bottom rail; and
a parallel linear section disposed on one or both sides of the central inclined section in parallel with respect to the length direction of the top or bottom rail.

107. The apparatus of claim 95, wherein the at least one inclined guide hole comprises:
a central first inclined section; and
a second inclined section formed on one side of the central first inclined section, which is inclined in the opposite direction to the first inclined section.

108. An apparatus for opening/closing a window in a sliding window system including a sliding window or sliding door, the apparatus comprising:
a roller assembly and a rail guide assembly mounted such that a movable window slidably moves along top and bottom rails fixed to a frame for opening and closing;
a movable window sash that fixedly supports a glass pane or panel, and that comprises an upper frame separated from the rail guide assembly and mounted under the rail guide assembly and a lower frame separated from the roller assembly and mounted on the roller assembly;
at least one inclined guide hole and at least one guide protrusion for respectively connecting between the separated upper frame and rail guide assembly and between the lower frame and the roller assembly;
an opening/closing device that is mounted on the movable window sash and applies a movement force including a direction component parallel with respect to the length direction of the top and bottom rails to the rail guide assembly and the roller assembly at any position on the top and bottom rails in order to generate a relative displacement between the at least one inclined guide hole and the at least one guide protrusion, the relative displacement including a component of displacement perpendicular with respect to the length direction of the top and bottom rails; and
a sheet-type lubricant member interposed at a boundary between the lower frame of the movable window sash and the roller assembly to prevent concentration of friction at the boundary and reduce frictional resistance.

109. The apparatus of claim 108, wherein:
the opening/closing device respectively applies a movement force of the same parallel direction with respect to a length direction of the rail to the roller assembly and the rail guide assembly in upper and lower structures of the movable window sash; and
the at least one inclined guide hole respectively formed in the upper and lower structures of the movable window sash are inclined in the same direction to each other when viewed from a plane of the movable window sash.

110. The apparatus of claim 108, wherein:
the opening/closing device applies a movement force to the roller assembly and the rail guide assembly in laterally opposite directions and in the parallel direction with respect to a length of the rail; and
the at least one inclined guide hole respectively formed in the upper and lower structures of the movable window sash are inclined in opposite directions that are bilaterally symmetric to each other when viewed from a plane of the movable window sash.

111. A method for opening/closing a window in a sliding window system, the method comprising:
separating upper and lower frames of a movable window sash that comes in contact with a frame during a seal operation from a rail guide assembly and a roller assembly;
providing connecting members to connect between the upper frame of the movable window sash and the rail guide assembly and between the lower frame and the roller assembly;
operating an opening/closing device such that the connecting members slide on the roller assembly and the rail guide assembly in an inclined direction at any position on top and bottom rails; and
moving the upper and lower frames of the movable window sash separated from the rail guide assembly and roller assembly in a front or rear direction that is perpendicular to the length direction of the top and bottom rails as the inclined sliding occurs, so that the movable window sash contacts a seal member interposed between the frame and the movable window sash at uniform pressure in the same direction during closing or is separated from the seal member during opening.

112. A method for opening/closing a window in a sliding window system, the method comprising:
separating upper and lower frames of a movable window sash that comes in contact with a frame during a seal operation from a rail guide assembly and a roller assembly, respectively forming at least one inclined guide hole and at least one guide protrusion between the upper frame of the movable window sash and the rail guide assembly and between the lower frame and the roller assembly, and fitting the at least one guide protrusion into the at least one inclined guide hole to connect between the upper frame and the rail guide assembly and between the lower frame and the roller assembly;
operating an opening/closing device such that sliding occurs between the at least one inclined guide hole and the at least one guide protrusion on the roller assembly and the rail guide assembly in an inclined direction at any position on top and bottom rails; and
moving the upper and lower frames of the movable window sash separated from the rail guide assembly and roller assembly in a front or rear direction that is perpendicular to the length direction of the top and bottom rails, so that the movable window sash contacts a seal member interposed between the frame and the movable window sash at uniform pressure in the same direction during closing or is separated from the seal member during opening.

113. The method of claim 112, wherein in separating the upper and lower frames of the movable window sash and forming the at least one inclined guide hole and the at least one guide protrusion for connection, a sheet-type lubricant member is mounted at a boundary between the lower frame of the movable window sash and the roller assembly to prevent concentration of friction and reduce frictional resistance at the boundary when the upper and lower frames of the movable window sash move in a front or rear direction that is perpendicular to the length direction of the top and bottom rails.
